(19) United States
(12) Patent Application Publication
(10) Pub. No.: US 2010/0211949 A1
(43) Pub. Date: Aug. 19, 2010

(54) Management computer and processing management method

(75) Inventors: Jun Nakajima, Kawasaki (JP); Yukinori Sakashita, Sagamihara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/385,491

(22) Filed: Apr. 9, 2009

(30) Foreign Application Priority Data
Feb. 16, 2009 (JP) 2009-032742

(51) Int. Cl. G06F 9/46

(52) U.S. Cl. 718/100

(57) ABSTRACT

Provided is a management computer coupled to a host computer and a storage system including a plurality of storage devices, the management computer comprising: a memory storing configuration information including information on a resource included in an I/O path from the host computer to the plurality of storage devices; and a processor associating, first processing involving a change in a configuration of the resource, the resource to be processed by the first processing and an execution purpose of the first processing with the first processing, and managing the first processing associated with the resource and the execution purpose. The processor extracts other processing which processes the resource to be processed by the first processing, and refers to the resource to be processed by the extracted other processing and an execution purpose of the other processing, to thereby determine whether the first processing needs to be executed or not.

### CLAIM OF PRIORITY

The present application claims priority from Japanese patent application JP 2009-32742 filed on Feb. 16, 2009, the content of which is hereby incorporated by reference into this application.

### BACKGROUND

This invention relates to a computer system provided with a storage system. In particular, this invention relates to a method, in a storage area network (referred to as SAN hereinafter), for managing functions provided by the storage system as tasks.

Recently, the storage system provides various management functions. For example, the management functions include data migration (refer to U.S. Pat. No. 5,956,750 and U.S. Pat. No. 6,108,748).

The data migration is a technology for moving data stored in a logical disk from an arbitrary physical disk to another physical disk.

The storage system, for the data migration, need to acquire information on various performances in the SAN. The information on various performances in the SAN includes, for example, information on resources contained in an I/O path to a memory device to which a logical volume used by software running on a computer in the SAN belongs.

As a method for acquiring the above-mentioned information, for example, a performance/information collection program is possibly used (refer to U.S. Pat. No. 7,127,555 B2, for example).

The storage system provides, in addition to the data migration, data copy, setting a path to a logical volume, inhibiting access to a logical volume, and shredding of data in a logical volume as the management functions.

### SUMMARY

An administrator of the SAN uses the respective functions provided by the storage system from various administrative viewpoints such as performance, cost, capacity, archive, and replacement.

The administrator of the SAN, from various administrative viewpoints such as performance, cost, capacity, archive, and replacement, sequentially carries out pieces of processing (referred to as tasks hereinafter) such as those for improving the performance and changing the configuration.

In the above-mentioned environment, a time lag may be generated between planning of the task execution and an actual start of the task execution. The time lag is generated when tasks are pieces of processing carried out for the same resources, and are not executed simultaneously, or when there are tasks which are carried out asynchronously such as scheduling tasks.

In the above-mentioned environment, for example, before an arbitrary task (referred to as a second task hereinafter) is executed, due to influence of a task (referred to as first task hereinafter) executed from an administrative viewpoint different from that of the second task, respective types of information in the storage system when execution of the second task is planned are different from the respective types of information in the storage system when the execution of the first task actually starts.

In the above-mentioned case, even when the execution of the first task has already improved a performance, the second task may be executed, which is no longer necessary. Conventionally, it has been difficult to restrain execution of unnecessary administrative operations as described above.

A representative aspect of this invention is as follows. That is, there is provided a management computer coupled to a host computer and a storage system including a plurality of storage devices, generating a logical volume from the plurality of storage devices, and allocating the generated logical volume as an allocated logical volume to the host computer. The management computer comprising: a memory storing configuration information including information on a resource included in an I/O path from the host computer to the plurality of storage devices used to generate the allocated logical volume; and a processor associating, in a case where first processing involving a change in a configuration of the host computer or the storage system is planned, the resource to be processed by the first processing and an execution purpose of the first processing, and managing the resource and the execution purpose. The processor extracts other processing which processes the resource to be processed by the first processing, and refers to the resource to be processed by the extracted other processing and an execution purpose of the other processing, to thereby determine whether the first processing needs to be executed or not.

According to a representative aspect of this invention, unnecessary processing can be eliminated. As a result, an administrator or a system management software program can carry out only required minimum processing.

### BRIEF DESCRIPTION OF THE DRAWINGS

The present invention can be appreciated by the description which follows in conjunction with the following figures, wherein:

FIG. 1 is a block diagram illustrating an example of a configuration of a SAN according to a first embodiment of this invention;

FIG. 2 is a block diagram illustrating an example of a configuration of a management server according to the first embodiment of this invention;

FIG. 3 is a block diagram illustrating an example of a configuration of a storage system according to the first embodiment of this invention;

FIG. 4 is a block diagram illustrating an example of a configuration of a host according to the first embodiment of this invention;

FIG. 5 is an explanatory diagram illustrating an example of a task management table stored in a system management repository according to the first embodiment of this invention;

FIG. 6 is an explanatory diagram illustrating an example of a configuration information table stored in the system management repository according to the first embodiment of this invention;

FIG. 7 is an explanatory diagram illustrating an example of a performance information table stored in the system management repository according to the first embodiment of this invention;

FIG. 8 is an explanatory diagram illustrating an example of a migration management table stored in the system management repository according to the first embodiment of this invention;

FIG. 9 is an explanatory diagram illustrating an example of a task classification table stored in the system management repository according to the first embodiment of this invention;

FIG. 10 is a flowchart illustrating an example of an overview of a task management processing carried out by the management server according to the first embodiment of this invention;

FIG. 11 is a flowchart detailing a processing carried out to register a new task in the task management table by a task management program stored in the management server according to the first embodiment of this invention;

FIG. 12 is a flowchart detailing processing carried out to investigate a relationships between a new task and a planned tasks by an inter-task relationship extraction program stored in the management server according to the first embodiment of this invention;

FIG. 13 is a flowchart detailing processing carried out to determine whether a new task is to be executed or not by a task execution determination program stored in the management server according to the first embodiment of this invention;

FIG. 14 is a block diagram illustrating an example of a configuration of a management server according to a second embodiment of this invention;

FIG. 15 describes an example of a task management table stored in a system management repository according to the second embodiment of this invention;

FIG. 16 is a flowchart detailing a processing carried out to investigate a relationships between a new task and a planned tasks by an inter-task relationship extraction program stored in the management server according to the second embodiment of this invention;

FIG. 17 is a flowchart detailing a processing carried out to determine by a task execution determination program stored in the management server whether or not a new task is to be executed according to the second embodiment of this invention;

FIG. 18 is a block diagram illustrating an example of a configuration of the management server according to a third embodiment of this invention;

FIG. 19 is an example of a task management table stored in a system management repository according to the third embodiment of this invention;

FIG. 20 is an example of a configuration information table stored in the system management repository according to the third embodiment of this invention;

FIG. 21 is an example of a migration management table stored in the system management repository according to the third embodiment of this invention;

FIG. 22 is an example of an access management table stored in the system management repository according to the third embodiment of this invention;

FIG. 23 is an example of a performance history table stored in the system management repository according to the third embodiment of this invention;

FIG. 24 is a flowchart detailing a processing carried out to register a new task to a task management table by a task management program stored in the management server according to the third embodiment of this invention;

FIG. 25 is a flowchart detailing a processing carried out to determine by a task execution determination program stored in the management server whether or not a new task is to be executed according to the third embodiment of this invention;

FIG. 26 is a block diagram illustrating an example of a configuration of a SAN according to a fourth embodiment of this invention;

FIG. 27 is a block diagram illustrating an example of a configuration of a management server according to the fourth embodiment of this invention;

FIG. 28 is a block diagram illustrating an example of a configuration of a storage system according to the fourth embodiment of this invention;

FIG. 29 is an example of a task management table stored in a system management repository according to the fourth embodiment of this invention;

FIG. 30 is an example of a configuration information table stored in the system management repository according to the fourth embodiment of this invention;

FIG. 31 is an example of a capacity information table stored in the system management repository according to the fourth embodiment of this invention;

FIG. 32 is an explanatory diagram illustrating an example of a migration management table stored in the system management repository according to the fourth embodiment of this invention;

FIG. 33 is an example of a virtualized pool management table stored in the system management repository according to the fourth embodiment of this invention;

FIG. 34 is a flowchart detailing processing carried out to register a new task in a task management table by a task management program stored in the management server according to the fourth embodiment of this invention; and

FIGS. 35A and 35B are flowcharts detailing processing carried out to determine whether a new task is to be executed or not by a task execution determination program stored in a management server according to the fourth embodiment of this invention.

### DETAILED DESCRIPTION OF THE PREFERRED EMBODIMENTS

A description is now given of representative embodiments of this invention referring to drawings. It should be noted that this invention is not limited to the embodiments described below.

### First Embodiment

First, a description is given of a configuration of a SAN.

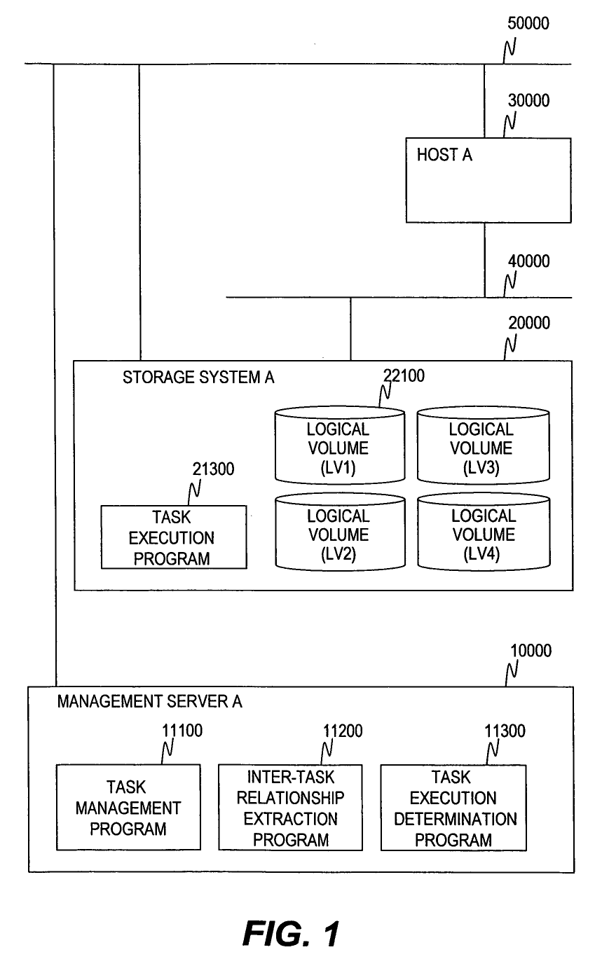

FIG. 1 is a block diagram illustrating an example of the configuration of the SAN according to a first embodiment of this invention.

The SAN according to the first embodiment includes at least one host 30000, at least one storage system 20000, and at least one management server 10000.

The storage system 20000 stores a task execution program 21300. The task execution program 21300 is a program for realizing functions provided by the storage system 20000.

Moreover, on the storage system 20000, a plurality of logical volumes 22100 are created, and the logical volumes 22100 are provided for the hosts 30000. In the example illustrated in FIG. 1, the storage system 20000 (storage system A) provides the host 30000 (host A) with logical volumes 22100 (LV1 to LV4).

The management server 10000 stores a task management program 11100, an inter-task relationship extraction program 11200, and a task execution determination program 11300.

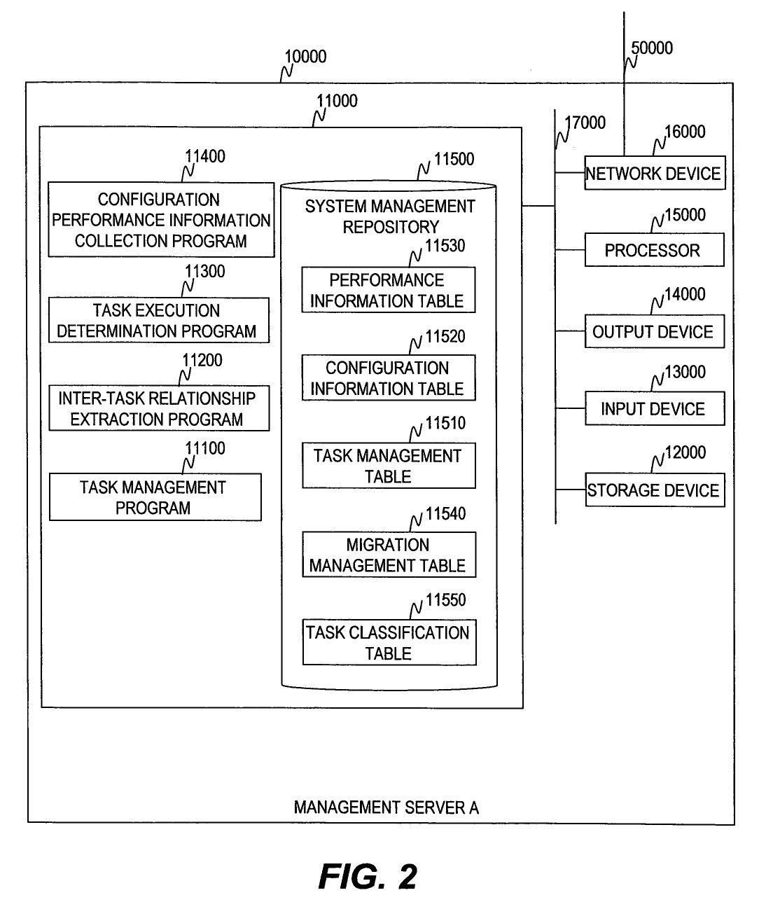

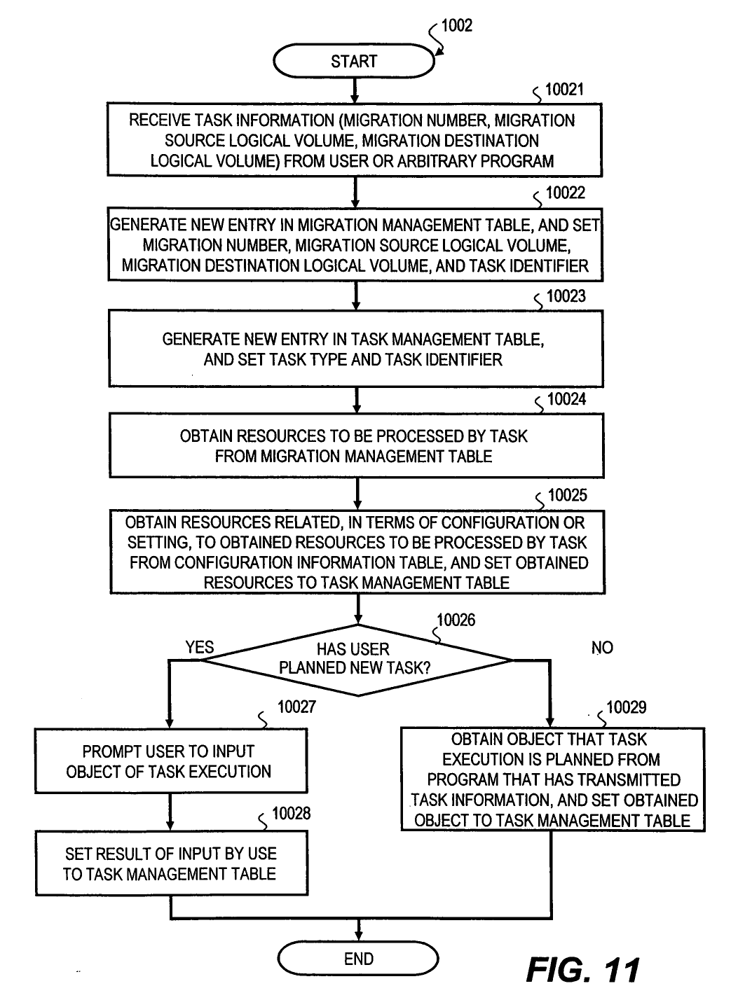

The task management program 11100 is a program for creating a task management table 11510 illustrated in FIG. 2. A detailed description is later given of the processing of the task management program 11100 referring to FIG. 11.

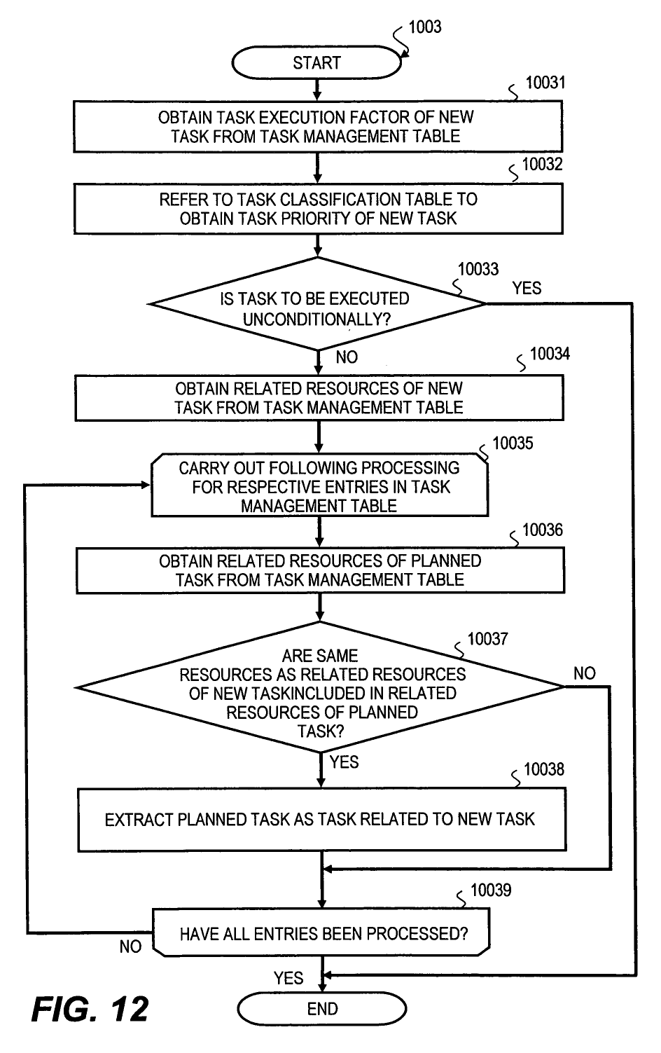

The inter-task relationship extraction program 11200 is a program for investigating relationships between a newly planned task and tasks already planned. A detailed description is later given of the processing of the inter-task relationship extraction program 11200 referring to FIG. 12.

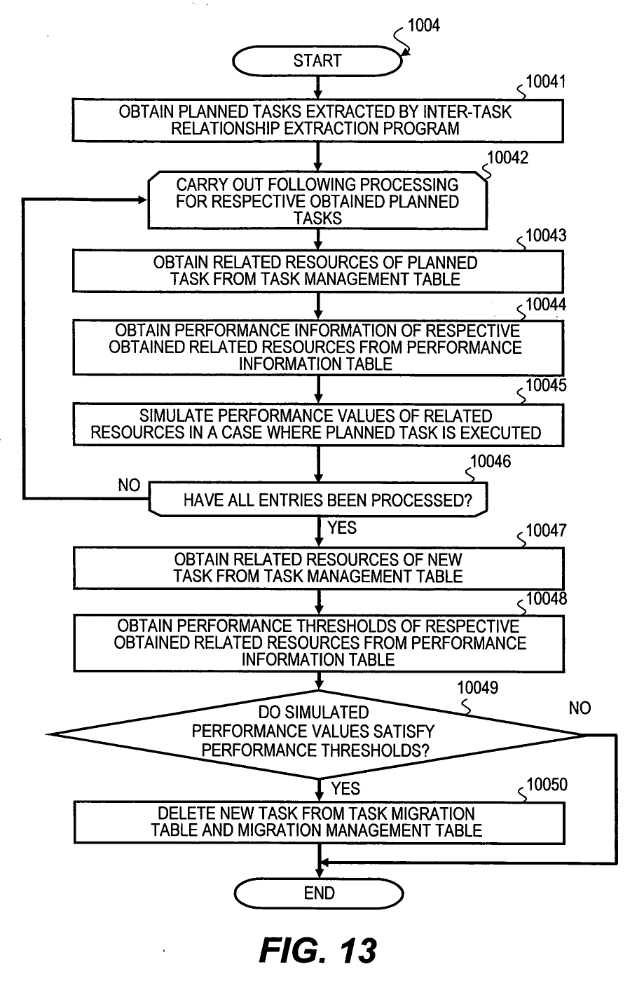

The task execution determination program 11300 is a program for determining whether a newly planned task is to be executed or not. A detailed description is later given of the processing of the task execution determination program 11300 referring to FIG. 13.

The host 30000 carries out various business tasks by using the logical volumes 22100 provided by the storage system 20000.

The host 30000 (host A) and the storage system 20000 (storage system A) are coupled with each other via a fibre channel 40000.

The management server 10000 (management server A) is coupled to the storage system 20000 (storage system A) and the host 30000 (host A) via a management network 50000. The management server 10000 (management server A) can communicate with the task execution program 21300 via the management network 50000.

In the example illustrated in FIG. 1, the management server 10000 stores the task management program 11100, the inter-task relationship extraction program 11200, and the task execution determination program 11300, but this invention is not limited to this configuration. For example, the storage system 20000 or the host 30000 may store those programs. Moreover, other devices such as switches (not shown) provided between the respective devices may store the above-mentioned programs.

Moreover, the storage system 20000 stores the task execution program 21300, but this invention is not limited to this configuration. For example, the management server 10000 or the host 30000 may store the task execution program 21300. Moreover, other devices such as switches (not shown) provided between the respective devices may store the task execution program 21300.

Moreover, the coupling between the host 30000 (host A) and the storage system 20000 (storage system A) is not limited to the direct coupling via the fibre channel 40000, and may be interposed by at least one network device such as a fiber channel switch. Moreover, the coupling between the host 30000 (host A) and the storage system 20000 (storage system A) may be any network for data communication such as an IP network, for example.

FIG. 2 is a block diagram illustrating an example of the configuration of the management server 10000 according to the first embodiment of this invention.

The management server 10000 is provided with a memory 11000, a storage device 12000, an input device 13000, an output device 14000, a processor 15000, and a network device 16000, and those components are coupled with each other via a communication line 17000 such as an internal bus.

The memory 11000 stores the task management program 11100, the inter-task relationship extraction program 11200, the task execution determination program 11300, a configuration/performance information collection program 11400, and a system management repository 11500.

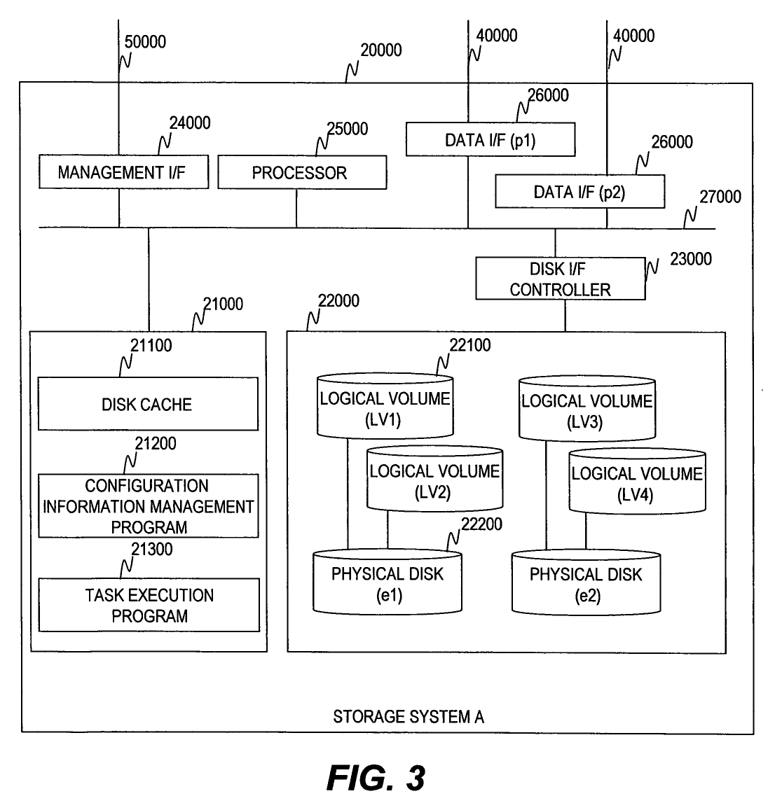

The configuration/performance information collection program 11400 is a program for acquiring information on resources contained in an I/O path to a physical disk 22200, illustrated in FIG. 3, on which a logical volume 22100 used by a software program (not shown) running on the host 30000 is created.

The system management repository 11500 stores the task management table 11510, a configuration information table 11520, a performance information table 11530, a migration management table 11540, and a task classification table 11550.

The task management table 11510 stores information on task types, task execution factors, and resources related to the tasks. The configuration information table 11520 stores configuration information on the SAN. The performance information table 11530 stores, performance information on devices coupled to the SAN and resources in the devices. The migration management table 11540 stores information on migration processing. The task classification table 11550 stores priorities of tasks.

The storage device 12000 is an HDD or the like for storing information. The input device 13000 is a keyboard or the like used by a SAN administrator to input instructions to the task management program 11100. The output device 14000 is a display device outputting an execution result of processing carried out by the task management program 21300. The processor 15000 executes programs loaded on the memory 11000. The network device 16000 is a device used for coupling to the management network 50000.

In an example illustrated in FIG. 2, the above-mentioned programs and tables are stored in the memory 11000, but those programs and tables may be stored in the storage device 12000 or other recording media (not shown). In this case, the processor 15000, when executing programs, reads the above-mentioned programs and tables on the memory 11000, and executes the read programs.

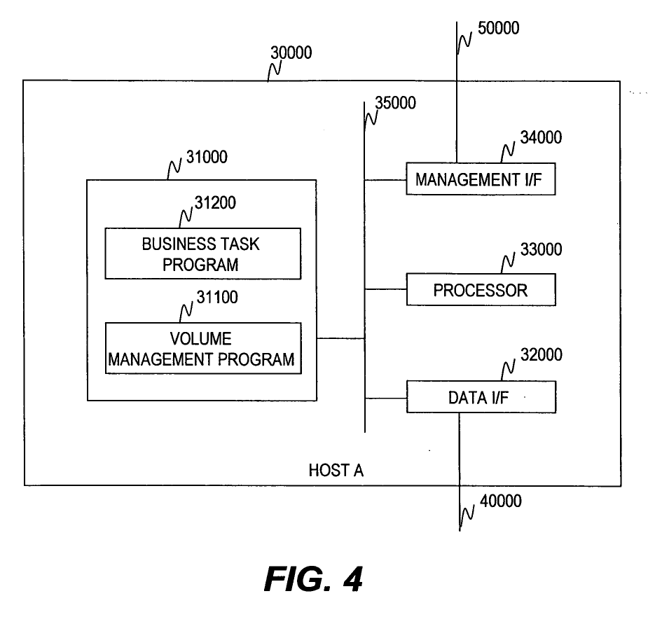

Moreover, the above-mentioned programs and tables may be stored in a memory 31000 of the host 30000 illustrated in FIG. 4 or a memory 21000 of the storage system 20000 illustrated in FIG. 3, and the host 30000 or the storage system 20000 may execute the stored programs. Moreover, other devices such as other servers (not shown) and fibre channel switches (not shown) may store the above-mentioned programs and tables, and may execute the stored programs.

FIG. 3 is a block diagram illustrating an example of the configuration of the storage system 20000 according to the first embodiment of this invention.

The storage system 20000 is provided with the memory 21000, a logical volume providing unit 22000, a disk I/F controller 23000, a management I/F 24000, a processor 25000, and a data I/F 26000, and those components are coupled with each other via a communication line 27000 such as an internal bus.

The memory 21000 stores a disk cache 21100, a configuration information management program 21200, and the task execution program 21300.

The disk cache 21100 is a storage volume for temporarily storing information. The configuration information management program 21200 is a program for transmitting and receiving management information and performance/capacity information on the storage system 20000 to/from the management server 10000.

The task execution program 21300 is a program for executing functions provided by the storage system 20000. According to the first embodiment, as the functions provided by the storage system 20000, namely, tasks executed by the task execution program 21300, data migration is described.

The logical volume providing unit 22000 is provided with a physical disk 22200. The logical volume providing unit 22000 logically divides the physical disk 22200 into storage volumes, and provides the logically divided storage volume as logical volume 22100. As a result, access to the logical volume 22100 from the outside of the storage system 20000 is enabled.

It should be noted that, to the physical disk 22000, a physical disk number is assigned, and to the logical volume 22100, a logical volume number is assigned. As a result, the storage system 20000 can uniquely identify the respective physical disks 22200 and logical volumes 22100. In the example illustrated in FIG. 3, it is appreciated that the storage system 20000 includes two physical disks 22200 respectively having physical disk numbers “e1” and “e2”, and four logical volumes 22100 respectively having logical volume numbers “LV1” to “LV4”.

In the example illustrated in FIG, 3, the two physical disks 22200 (e1, e2) are logically divided, thus, the four logical volumes 22100 (LV1 to LV4) are respectively created, and the logical volumes 22100 (LV1 to LV4) are provided for devices such as the host 30000 outside the storage system 20000.

The disk I/F controller 23000 is an interface used for coupling to the logical volume providing unit 22000. The management I/F 24000 is an interface used for coupling to the management network 50000. The processor 25000 executes programs loaded on the memory 21000.

The data I/F 26000 is an interface used for coupling to the fibre channel 40000. It should be noted that a plurality of disk I/F controllers 23000, management I/Fs 24000, and data I/Fs 26000 may be provided. In the example illustrated in FIG. 3, the storage system 20000 is provided with two data I/Fs 26000: a data I/F (p1) and a data I/F (p2).

In the example illustrated in FIG. 3, the above-mentioned programs are stored in the memory 21000, but the programs may be stored in other storage devices (not shown) or other recording media (not shown). In this case, the processor 25000, when carrying out processing, reads the above-mentioned programs on the memory 21000, and executes the read programs.

Moreover, the above-mentioned programs may be stored in the memory 31000 of the host 30000 illustrated in FIG. 4 or the memory 21000 of the storage system 20000 illustrated in FIG. 3, and the host 30000 or the storage system 20000 may execute the stored programs. Moreover, other storage systems (not shown) may store the above-mentioned programs, and may execute stored programs.

Moreover, the logical volume providing unit 22000 may logically split a RAID group constituted by a plurality of physical disks 22200, thereby creating logical volumes 22100. Moreover, the logical volume providing unit 22000 may create one logical volume 22100 from an entire storage volume of one physical disk 22200. Moreover, the logical volume providing unit 22000 may create logical volumes 22100 from storage volumes of storage media such as flash memories other than the physical disks 22200.

FIG. 4 is a block diagram illustrating an example of the configuration of the host 30000 according to the first embodiment of this invention.

The host 30000 is provided with a memory 31000, a data I/F 32000, a processor 33000, and a management I/F 34000, and they are coupled with each other via a communication path 35000 such as an internal bus.

The memory 31000 stores a volume management program 31100, and a business task program 31200.

The volume management program 31100 is a program used for allocating the logical volumes 22100 provided for the SAN to the host 30000. The business task program 31200 is a program for realizing business tasks carried out by the host 30000, and is a database management system (DBMS), a file system, or the like.

The host 30000, by using the logical volumes 22100 allocated by the volume management program 31100, carries out the business tasks.

The data I/F 32000 is an interface used for coupling to the fibre channel 40000. The processor 33000 executes programs loaded on the memory 31000. The management I/F 34000 is an interface used for coupling to the management network 50000. It should be noted that a plurality of data I/Fs 32000 and management I/Fs 34000 may be provided.

In the example illustrated in FIG. 4, the above-mentioned programs are stored in the memory 31000, but the programs may be stored in other storage devices (not shown) or other recording media (not shown). In this case, the processor 33000, when executing processing, reads the above-mentioned programs on the memory 31000, and executes the read programs.

Moreover, the above-mentioned programs may be stored in the memory 31000 of the host 30000 or the memory 21000 of the storage system 20000, and the host 30000 or the storage system 20000 may execute the stored programs. Moreover, other storage systems (not shown) may store the above-mentioned programs, and may execute stored programs.

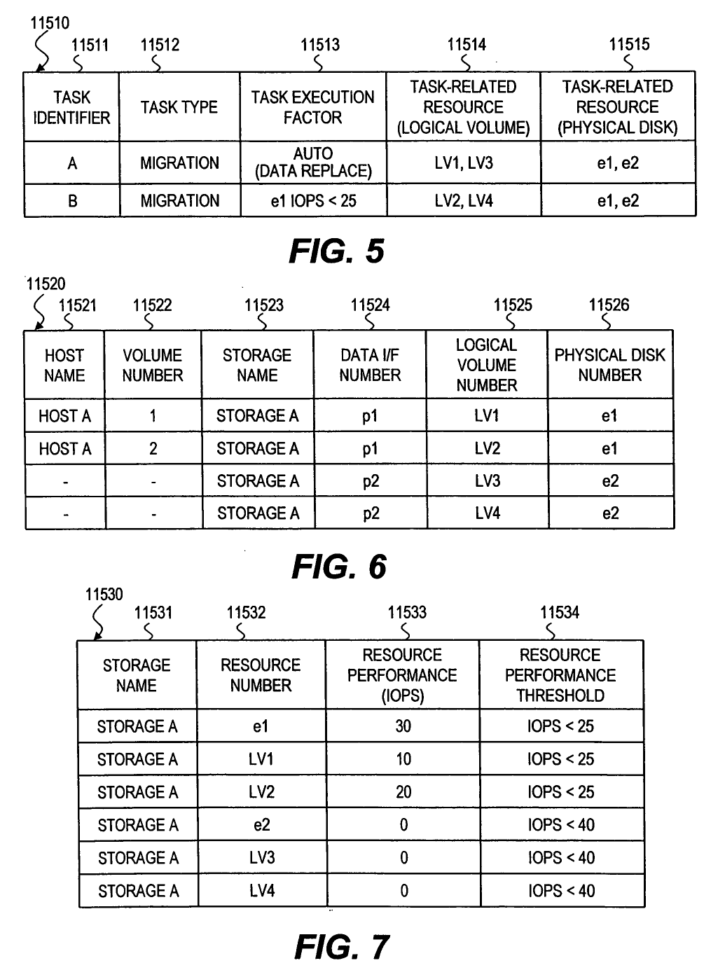

FIG. 5 describes an example of the task management table 11510 stored in the system management repository 11500 according to the first embodiment of this invention.

The task management table 11510 stores, for respective tasks, information on an execution object, contents of processing, and resources related to the tasks. As a result of the execution of the task management program 11100, a record is added to the task management table 11510.

The task management table 11510 contains task identifiers 11511, task types 11512, task execution factors 11513, task-related resources (logical volumes) 11514, and task-related resources (physical disks) 11515.

The task identifier 11511 stores an identifier used for uniquely identifying a task. The task type 11512 stores a type of the task. The task execution factor 11513 stores an index and a value of the index which cause the execution of the task corresponding to the task identifier 11511.

The task-related resource (logical volume) 11514 stores logical volume numbers for uniquely identifying logical volumes 22100 related to the task corresponding to the task identifier 11511. The task-related resource (physical disk) 11515 stores physical disk numbers for uniquely identifying physical disks 22200 related to the task corresponding to the task identifier 11511.

In the example illustrated in FIG. 5, it is appreciated that a task having the task identifier 11511 of “A” has, as related resources, the logical volumes 22100 having the logical volume numbers of “LV1” and “LV3”, and physical disks 22200 having the physical disk numbers of “e1” and “e2”, and is migration for data replacement. Moreover, it is appreciated that a task having the task identifier 11511 of “B” has, as related resources, the logical volumes 22100 having the logical volume numbers of “LV2” and “LV4”, and the physical disks 22200 having the physical disk numbers of “e1” and “e2”, and is migration for performance improvement coping with a decrease in performance.

According to the first embodiment, as the task-related resources, the logical volumes 22100 and the physical disks 22200 are described, but this invention is not limited thereto. For example, the task-related resources may include a host 30000 using a logical volume 22100, and a switch (not shown) or a data I/F 26000 of the storage system 20000 through which data passes when the host 30000 writes the data to the logical volume 22100.

Moreover, the task-related resources may include a resource for holding information on setting and information on set status between logical volumes 22100, such as information on copy and backup.

FIG. 6 describes an example of the configuration information table 11520 stored in the system management repository 11500 according to the first embodiment of this invention.

The configuration information table 11520 stores information on a path which is used by a host 30000 for making access to a logical volume 22100, and extends between the host 30000 and a physical disk 22200 on which the logical volume 22100 provided for the host 30000 is created. As a result of execution of the configuration/performance information collection program 11400, a record is added to the configuration information table 11520.

The configuration information table 11520 includes host names 11521, volume numbers 11522, storage names 11523, data I/F numbers 11524, logical volume numbers 11525, and physical disk numbers 11526.

The host name 11521 stores an identifier used for uniquely identifying a host 30000. The volume number 11522 stores an identifier used for uniquely identifying a volume provided for the host 30000 corresponding to the host name 11521. It should be noted that the volume is a volume recognized by the host 30000.

The storage name 11523 stores an identifier used for uniquely identifying a storage system 20000 providing the volume corresponding to the volume number 11522. The data I/F number 11524 stores an identifier used for uniquely identifying the number of a data I/F 26000 used by the host 30000 for making access to the volume corresponding to the volume number 11522.

The logical volume number 11525 stores an identifier used for uniquely identifying a logical volume 22100 used by the volume corresponding to the volume number 11522. The physical disk number 11526 stores an identifier for uniquely identifying a physical disk 22200 on which the logical volume 22100 corresponding to the logical volume number 11525 is created.

It should be noted that a record which stores “-” in the host name 11521 and the volume number 11522 represents a state in which a storage is not allocated to a host 30000.

In the example illustrated in FIG. 6, it is appreciated that, to a volume having the volume number 11522 of “1” provided for a host having the host name 11521 of “HOST A”, a logical volume having the logical volume number 11525 of “LV1” created from a physical disk 22200 having the physical disk number 11526 of “e1” in a storage having the storage name 11523 of “STORAGE A” is allocated via a data I/F 26000 having the data I/F number 11524 of “p1”.

Moreover, it is appreciated that, to a volume having the volume number 11522 of “2” provided for a host having the host name 11521 of “HOST A”, a logical volume having the logical volume number 11525 of “LV2” created from a physical disk 22200 having the physical disk number 11526 of “e1” in a storage having the storage name 11523 of “STORAGE A” is allocated via a data I/F 26000 having the data I/F number 11524 of “p1”.

Moreover, it is appreciated that, to a storage system 20000 having the storage name 11523 of “STORAGE A”, a host 30000 is not allocated. Moreover, it is appreciated that, on a physical disk 22200 having the physical disk number 11526 of “e2” in the storage system 20000 having the storage name 11523 of “STORAGE A”, logical volumes 22100 having the logical volume numbers 11525 of “LV3” and “LV4” are created.

FIG. 7 describes an example of the performance information table 11530 stored in the system management repository 11500 according to the first embodiment of this invention.

The performance information table 11530 stores performance information of SAN components such as logical volumes 22100 and physical disks 22200 in the respective storage systems 20000, and performance thresholds of the SAN components.

On this occasion, the performance threshold represents a value set in advance to a resource to be managed in order to monitor changes in I/O. As a result, when a value of performance information exceeds a performance threshold during operation, for example, the management server 10000 can take an action such as report to a user.

As a result of execution of the configuration/performance information collection program 11400, a record is added to the performance information table 11530.

The performance information table 11530 contains storage names 11531, resource numbers 11532, resource performances (IO per second: IOPS) 11533, and resource performance thresholds 11534.

The storage name 11531 is the same as the storage name 11523 of FIG. 6. The resource number 11532 stores a logical volume number or a physical disk number used for uniquely identifying a logical volume 22100 or a physical disk 22200 in a storage system 20000 corresponding to the storage name 11531.

The resource performance (IOPS) 11533 stores the number of I/Os per unit time (one second according to the first embodiment) carried out on the logical volume 22100 or the physical disk 22200. The resource performance threshold 11534 stores a threshold set in advance in the logical volume 22100 or the physical disk 22200 corresponding to the resource number 11532.

The threshold stored in the resource performance threshold 11534 has been determined in advance according to the configuration of the SAN when the SAN has been configured. Moreover, an administrator of the SAN can properly change the thresholds, and the resource performance thresholds 11534 hold the thresholds changed by the SAN administrator.

According to the first embodiment, the IOPS is used as the performance information on the resources, but other types of performance information such as IO Response Time, Read IO Per Second, Write IO Per Second, and Transfer Rate may be used.

Moreover, according to the first embodiment, in order to refer to the performance information as an index used for simulating influence of execution of a task, the management server 10000 includes the performance information table 11530, but this invention is not limited to this configuration. For example, the management server 10000 may be provided with a table containing an index used for monitoring with the use of thresholds in capacity information or cost information.

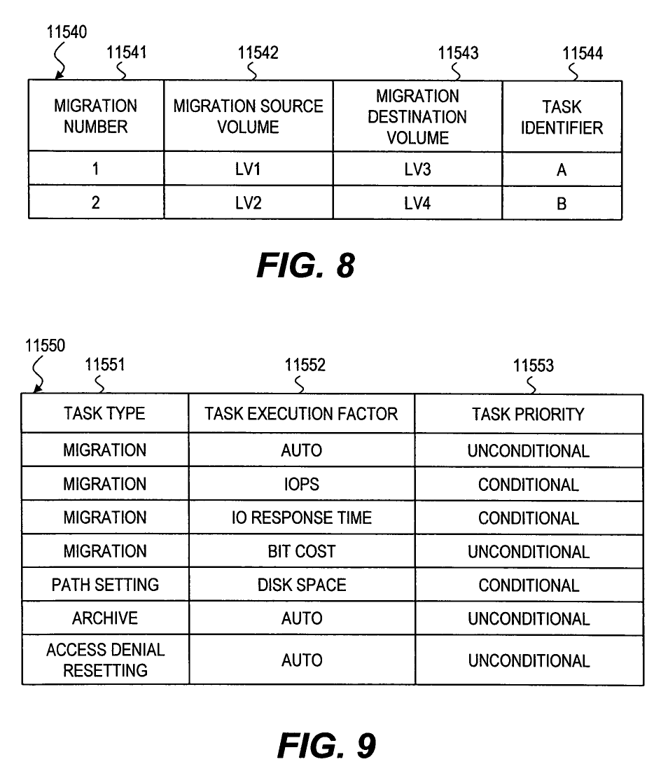

FIG. 8 describes an example of the migration management table 11540 stored in the system management repository 11500 according to the first embodiment of this invention.

The migration management table 11540 stores information required for migration carried out by the task execution program stored in the storage system 20000. As a result, the management server 10000 can manage the tasks and detailed information on the respective task types while they are associated with each other. To the migration management table 11540, as a result of the execution of the task management program 11100, a record is added.

The migration management table 11540 contains migration numbers 11541, migration source volumes 11542, migration destination volumes 11543, and task identifiers 11544.

The migration number 11541 stores an identifier used for uniquely identifying migration processing. The migration source volume 11542 stores a logical volume number of a logical volume 22100 which is a source of migration in the migration processing. The migration destination volume 11543 stores a logical volume number of a logical volume 22100 which is a destination of migration in the migration processing. The task identifier 11544 is the same as the task identifier 11511 of FIG. 5.

In the example illustrated in FIG. 8, it is appreciated that migration from a logical volume 22100 having the logical volume number of “LV1” to a logical volume 22100 having the logical volume number of “LV3”, and migration from a logical volume 22100 having the logical volume number of “LV2” to a logical volume 22100 having the logical volume number of “LV4” are registered.

According to the first embodiment, since the migration is considered as an example of the task, the management server 10000 is provided with the migration management table 11540, but this invention is not limited to this configuration. For example, the management server 10000 may manage other functions such as copying and path setting as the tasks, and may be provided with management tables corresponding to the respective functions.

FIG. 9 describes an example of the task classification table 11550 stored in the system management repository 11550 according to the first embodiment of this invention.

The task classification table 11550 is a table in which, based on a user input or a rule prescribed according to priorities of respective tasks, records are created.

The task classification table 11550 includes task types 11551, task execution factors 11552, and task priorities 11553.

The task type 11551 is the same as the task type 11512 of FIG. 5. The task execution factor 11552 is the same as the task execution factor 11513 of FIG. 5.

The task priority 11553 stores information on whether the task corresponding to the task type 11551 is always executed or not. Specifically, in the task priority 11553, “UNCONDITIONAL” or “CONDITIONAL” is stored, and “UNCONDITIONAL” indicates that the task is always executed, and “CONDITIONAL” indicates that execution of the task is to be determined.

It should be noted that a record having the task execution factor 11552 of “Auto” indicates a case in which a task is not executed based on a monitored threshold, or the task execution factor has not been acquired. In this case, in the task priority 11553 of this record, “UNCONDITIONAL” is stored.

In the example illustrated in FIG. 9, it is appreciated that, in the task priority 11553 of a migration task based on a threshold in performance information such as the IOPS and the IO Response Time, capacity information such as the Disk Space, and cost information such as the Bit Cost, “CONDITIONAL” is stored, and, in the task priority 11553 of a migration task and a path setting task to be automatically executed, “UNCONDITIONAL” is stored.

A description is now given of task management processing carried out by the management server 10000.

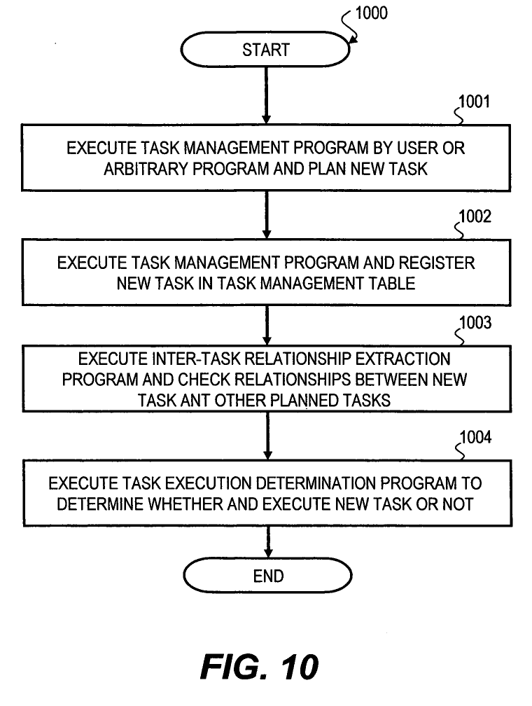

FIG. 10 is a flowchart illustrating an example of an overview of the task management processing carried out by the management server 10000 according to the first embodiment of this invention.

The task management processing 1000 is executed by the processor 15000 of the management server 10000 executing respective programs loaded on the memory 11000.

First, a new task is planned by a user or an arbitrary program executing the task management program 11100, and the management server 10000 receives information on this new task (Step 1001).

Then, the management server 10000, by executing the task management program 111000, based on the received information on the new task, registers the new task in the task management table 11510 (Step 1002).

Then, the management server 10000, by executing the inter-task relationship extraction program 11200, checks relationship between the new task and each of planned tasks (Step 1003).

The management server 10000, by executing the task execution determination program 11300, determines whether the new task is to be executed or not (Step 1004). A detailed description is now given of the respective pieces of processing in Steps 1002 to 1004.

FIG. 11 is a flowchart detailing the processing (Step 1002) carried out to register the new task in the task management table 11510 by the task management program 11100 stored in the management server 10000 according to the first embodiment of this invention.

The task management program 11100 receives task information on the task newly planned by a user or an arbitrary program (Step 10021). The task information contains a migration number, a migration source logical volume, and a migration destination logical volume.

The task management program 11100, based on the received task information, creates a new entry in the migration management table 11540, and sets the migration number 11541, the migration source volume 11542, the migration destination volume 11543, and the task identifier 11544 (Step 10022).

The task management program 11100, based on the received task information, creates a new entry in the task management table 11510, and sets the task type 11512 and the task identifier 11511 (Step 10023). It should be noted that, to the task identifier 11511, the same identifier as the task identifier 11544 in the migration management table 11540 is set.

The task management program 11100 refers to the migration management table 11540, and acquires information on resources to be processed by the task corresponding to the task identifier 11511 (Step 10024).

The task management program 11100 refers to the acquired information on the resources to be processed by the task, acquires resources related, in terms of configuration or setting, to those resources from the configuration information table 11520, and sets information on the acquired resources respectively to the task-related resources 11514 and 11515 in the task management table 11510 (Step 10025). As a result, not only logical volumes 22100 to be processed by the migration, but also physical disks 22200 on which the logical volumes 22100 are created are set as the related resources.

Then, the task management program 11100 determines whether the newly planned task is a task planned by a user or not (Step 10026).

When the task management program 11100 determines that the newly planned task is planned by a user, the task management program 11100 prompts the user to input an object of the task execution (Step 10027), sets a result of the user input to the task execution factor 11513 of the task management table 11510 (Step 10028), and finishes the processing.

In Step 10026, when the task management program 11100 determines that the newly planned task is not planned by a user, namely when the task is planned by an arbitrary program, the task management program 11100 acquires a reason of the planned task execution from the program which has transmitted the task information, sets the acquired reason of the planned task execution to the task execution factor 11513 of the task management table 11510 (Step 10029), and finishes the processing.

As a result of the above-mentioned processing, the task management table 11510 is created.

FIG. 12 is a flowchart detailing processing (Step 1003) carried out to investigate the relationships between the new task and the planned tasks by the inter-task relationship extraction program 11200 stored in the management server 10000 according to the first embodiment of this invention.

The inter-task relationship extraction program 11200 acquires the task execution factor 11513 of the new task from the task management table 11510 (Step 10031).

Then, the inter-task relationship extraction program 11200 acquires the task priority 11553 from the task classification table 11550 (Step 10032).

The inter-task relationship extraction program 11200 determines whether the new task is a task executed unconditionally (referred to as unconditional task hereinafter) or a task executed according to conditions (referred to as conditional task hereinafter) (Step 10033). In other words, the inter-task relationship extraction program 11200 determines whether the task priority 11553 of the new task is “UNCONDITIONAL” or “CONDITIONAL”.

On this occasion, an unconditional task is a task necessary to be surely executed, and a conditional task is a task not necessary to be executed when the task execution factor 11513 is resolved.

When the inter-task relationship extraction program 11200 determines that the new task is an unconditional task, the inter-task relationship extraction program 11200 finishes the processing.

In Step 10033, when the inter-task relationship extraction program 11200 determines that the new task is a conditional task, the inter-task relationship extraction program 11200 acquires related resources of the new task from the task management table 11510 (Step 10034). Specifically, the inter-task relationship extraction program 11200 acquires the task-related resource (logical volume) 11514 and the task-related resource (physical disk) 11515.

Then, the inter-task relationship extraction program 11200 carries out the following processing for respective records in the task management table 11510 (Step 10035).

The inter-task relationship extraction program 11200 acquires related resources of a planned task (task-related resource (logical volume) 11514 and the task-related resource (physical disk) 11515 in this case) from the task management table 11510 (Step 10036).

Then, the inter-task relationship extraction program 11200 compares the related resources of the new task and the related resources of the planned task, thereby determining that the same resources are contained (Step 10037).

When the inter-task relationship extraction program 11200 determines that the related resources of the planned task do not contain the same resources as the related resources of the new task, the inter-task relationship extraction program 11200 proceeds to Step 10039.

In Step 10037, when the inter-task relationship extraction program 11200 determines that the related resources of the planned task contain the same resources as the related resources of the new task, the inter-task relationship extraction program 11200 extracts the planned task from the task management table 11510 as a task related to the new task (Step 10038). Possible information on the planned task to be extracted includes the task identifier 11511 of the planned task related to the new task. Moreover, the extracted information on the planned task is stored in the memory 11000, for example.

The inter-task relationship extraction program 11200 determines whether all the entries have been processed in the task management table 11510 (Step 10039).

When the inter-task relationship extraction program 11200 determines that all the entries have not been processed in the task management table 11510, the inter-task relationship extraction program 11200 returns to Step 10035, and carries out the processing from Step 10035 to Step 10039.

In Step 10039, when the inter-task relationship extraction program 11200 determines that all the entries have been processed in the task management table 11510, the inter-task relationship extraction program 11200 finishes the processing.

As a result of the above-mentioned processing, the planned tasks related to the new task are extracted.

FIG. 13 is a flowchart detailing processing (Step 1004) carried out to determine whether the new task is to be executed or not by the task execution determination program 11300 stored in the management server 10000 according to the first embodiment of this invention.

First, the task execution determination program 11300 acquires the planned tasks extracted by the execution of the inter-task relationship extraction program 11200 (Step 10041).

Then, the task execution determination program 11300 carries out the following processing for the respective planned tasks acquired in Step 10041 (Step 10042).

The task execution determination program 11300 refers to the information on the each acquired planned task (task identifier 11511 of the planned task in this case), and acquires the related resources of the planned task (task-related resource (logical volume) 11514 and the task-related resource (physical disk) 11515 in this case) from the task management table 11510 (Step 10043).

Then, the task execution determination program 11300 refers to the acquired related resources of the planned task (task-related resource (logical volume) 11514 and the task-related resource (physical disk) 11515 in this case), and acquires performance information (resource performance (IOPS) 11533 in this case) of the respective acquired related resources from the performance information table 11530 (Step 10044).

The task execution determination program 11300 simulates performance values of the respective related resources when the planned task is executed (Step 10045).

Then, the task execution determination program 11300 determines whether all the acquired planned tasks have been processed (Step 10046).

When the task execution determination program 11300 determines that all the acquired planned tasks have not been processed, the task execution determination program 11300 returns to Step 10042, and carries out the processing from Step 10042 to Step 10046.

In Step 10046, when the task execution determination program 11300 determines that all the acquired planned tasks have been processed, the task execution determination program 11300 acquires the related resources of the new task (task-related resource (logical volume) 11514 and the task-related resource (physical disk) 11515 in this case) from the task management table 11510 (Step 10047).

Then, the task execution determination program 11300 refers to the related resources of the new task (task-related resource (logical volume) 11514 and the task-related resource (physical disk) 11515 in this case) acquired in Step 10047, and acquires performance thresholds (resource performances (IOPSes) 11533 in this case) of the respective acquired related resources of the new task from the performance information table 11530 (Step 10048).

Then, the task execution determination program 11300 determines whether, for all the related resources of the new task, the simulated performance value of the related resource of the planned task satisfies the acquired performance threshold of the related resource of the new task (Step 10049).

In Step 10049, when the task execution determination program 11300 determines that all the simulated performance values satisfy the corresponding performance thresholds, the task execution determination program 11300 deletes the records of the new task from the task management table 11510 and the migration management table 11540 (Step 10050), and finishes the processing.

In Step 10049, when the task execution determination program 11300 determines that there are simulated performance values which do not satisfy corresponding performance thresholds, the task execution determination program 11300 finishes the processing.

It should be noted that, in Step 10050, the task execution determination program 11300 may, in place of the deletion of the records of the new task from the task management table 11510 and the migration management table 11540, notify a user of warning asking whether the unnecessary processing to be executed will pose a problem or not.

Moreover, when the new task is carried out before the planned tasks, the task execution determination program 11300 may ask the user whether the user wants to attain the execution object by the planned task without the unnecessary processing by the new task, or to attain the execution object earlier by the new task. This corresponds to a case in which the new task is a task to be executed immediately, and the planned task is a scheduling task.

According to the first embodiment of this invention, “TASK B” is planned as the new task, and “TASK A” is extracted as the planned task related to the new task.

In this case, the task execution determination program 11300, for the logical volume 22100 (LV1, LV3) and the physical disk 22200 (e1, e2), which are the related resources of “TASK A”, by simulating the performance values of the related resources when the migration from the logical volume 22100 (LV1) to the logical volume 22100 (LV3) is carried out, can predict that the IOPS of the logical volume 22100 (LV1) becomes from 10 to 0, the IOPS of the logical volume 22100 (LV3) becomes from 0 to 10, the IOPS of the physical disk 22200 (e1) becomes from 30 to 20, and the IOPS of the physical disk 22200 (e2) becomes from 0 to 10.

In Step 10045, the value of the IOPS of a resource at the migration source is moved to the IOPS of a resource of the migration destination, but this invention is not limited to this method, and may carry out the simulation according to other method such as a method using history information.

As the result of the simulation in Step 10045, the task execution determination program 11300 recognizes that the performance thresholds of the logical volume 22100 (LV2, LV4) and the physical disk 22200 (e1, e2), which are the related resources of “TASK B” are satisfied, and can thus eliminate “TASK B” as an unnecessary task.

According to the first embodiment of this invention, by associating an execution factor of a task, and resources related to the task in terms of configuration or setting, as additional information, with the task, thereby managing the task associated with the additional information, the management server 10000 can determine, by simulating influence of tasks which have been planned in an aspect of management different from that of a new task, whether the execution of the new task is necessary or not. As a result, it is possible to eliminate a new task for which the execution is determined unnecessary.

### Second Embodiment

A description is now given of a second embodiment of this invention. The following description mainly focuses on differences from the first embodiment of this invention.

A configuration of the SAN, a configuration of the storage system 20000, and a configuration of the host 30000 are respectively the same as those illustrated in FIGS. 1, 3, and 4 according to the first embodiment, and hence description thereof is omitted.

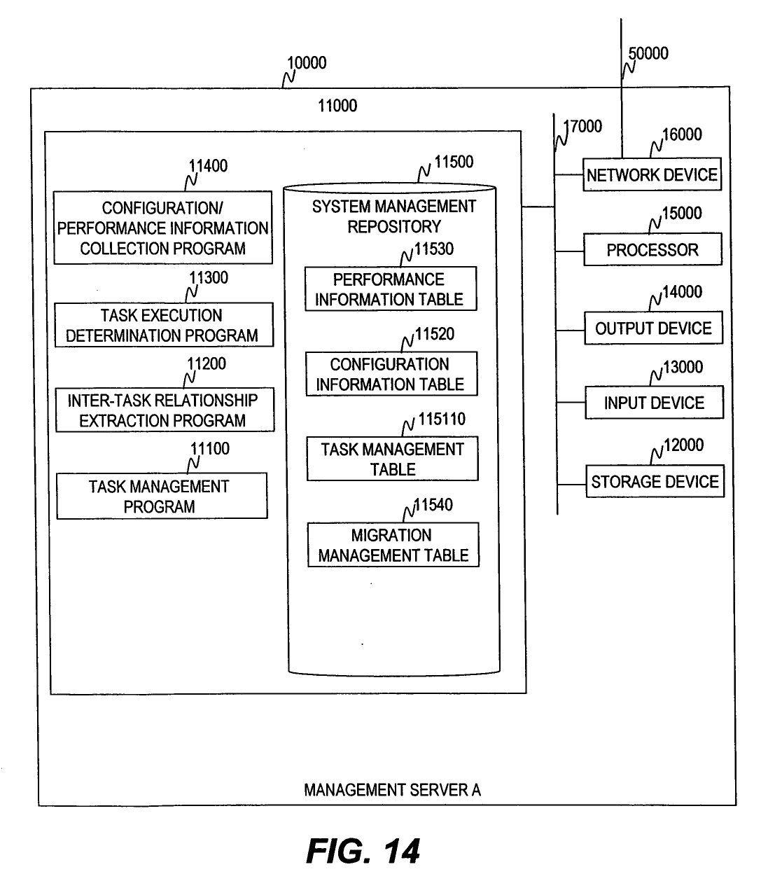

FIG. 14 is a block diagram illustrating an example of a configuration of a management server 10000 according to the second embodiment of this invention.

The management server 10000 includes the memory 11000, the storage device 12000, the input device 13000, the output device 14000, the processor 15000, and the network device 16000, and those components are coupled with each other via the communication line 17000 such as an internal bus.

The memory 11000 stores the task management program 11100, an inter-task relationship extraction program 11210, a task execution determination program 11310, the configuration/performance information collection program 11400, and the system management repository 11500.

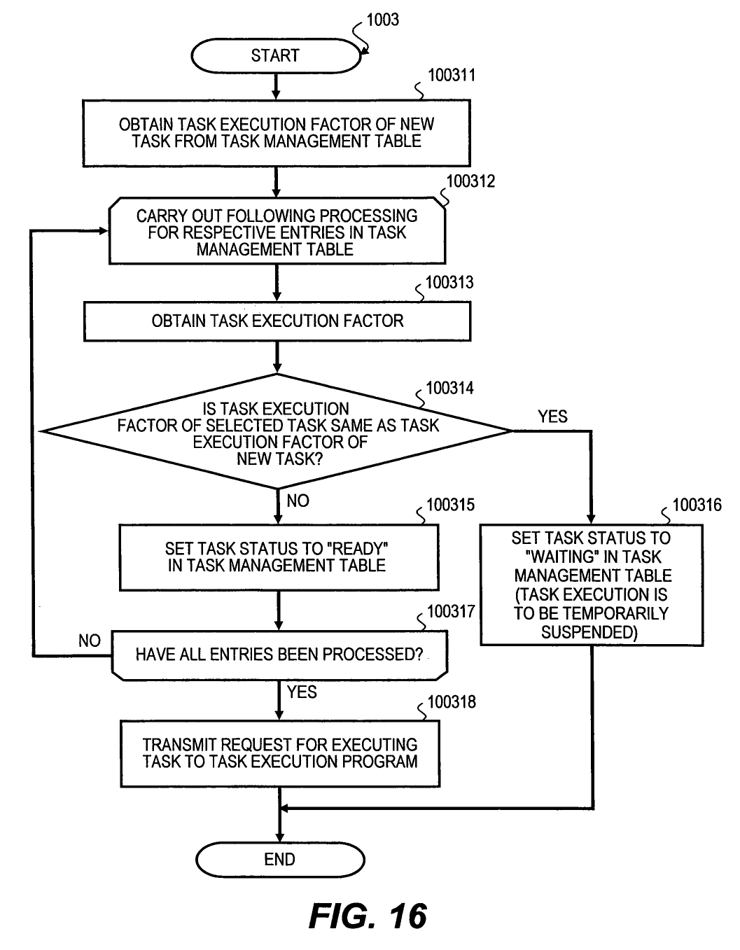

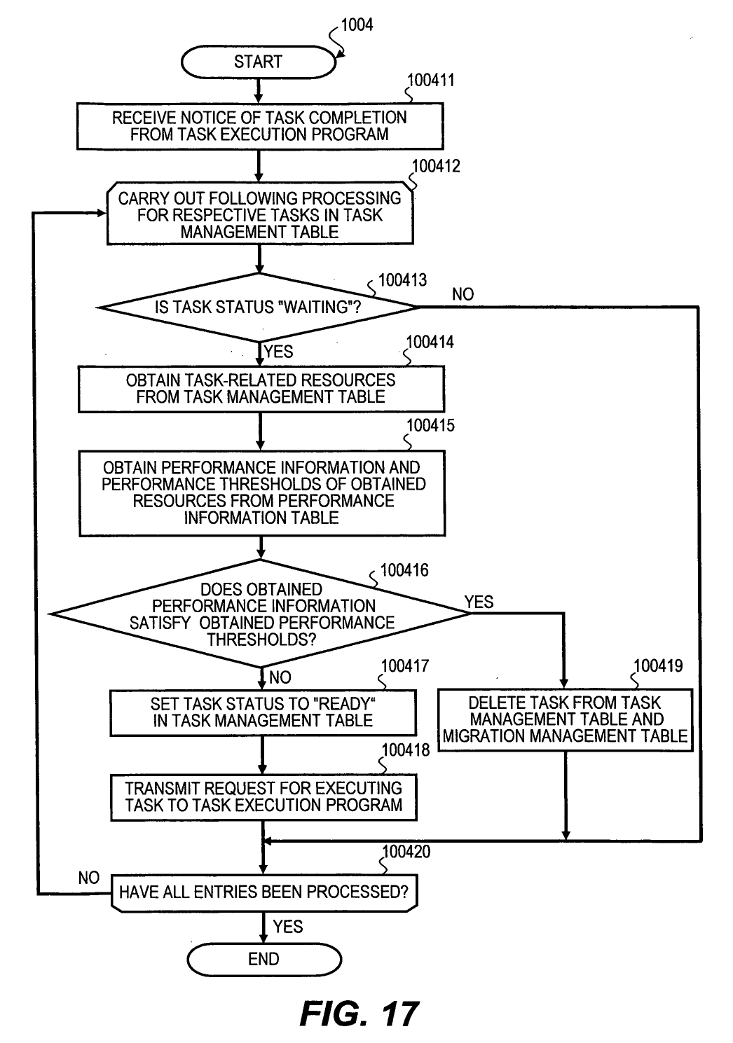

The task management program 11100 and the configuration/performance information collection program 11400 are the same as those of the first embodiment of this invention. A description is later given of specific processing carried out by the inter-task relationship extraction program 11210 and the task execution determination program 11310 referring to FIGS. 16 and 17.

The system management repository 11500 stores a task management table 115110, the configuration information table 11520, the performance information table 11530, and the migration management table 11540.

The task management table 115110 stores information on task types, task execution factors, and resources related to the tasks. The configuration information table 11520 stores configuration information on the SAN. The performance information table 11530 stores devices coupled to the SAN, and performance information on resources in the devices.

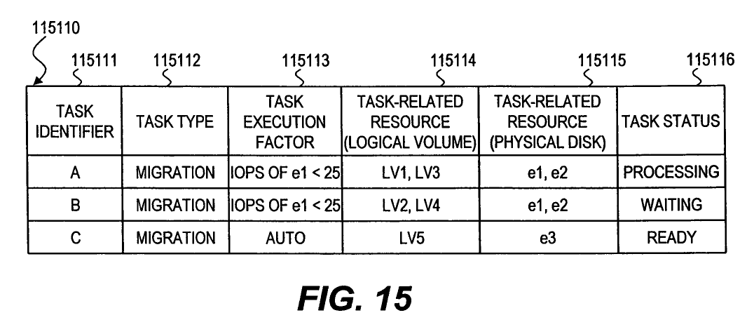

The configuration information table 11520, the performance information table 11530, and the migration management table 11540 are respectively the same as those illustrated in FIGS. 6, 7, and 8 according to the first embodiment of this invention, and hence description thereof is omitted. A detailed description is later given of the task management table 115110 with reference to FIG. 15.

The storage device 12000 is an HDD or the like for storing information. The input device 13000 is a keyboard or the like used by a SAN administrator to input instructions to the task management program 11100. The output device 14000 is a display device for outputting an execution result of processing carried out by the task management program 21300. The processor 15000 executes programs loaded on the memory 11000. The network device 16000 is a device used to couple to the management network 50000.

The storage device 12000, the input device 13000, the output device 14000, the processor 15000, and the network device 16000 are the same as those of the first embodiment of this invention.

In an example illustrated in FIG. 14, the above-mentioned programs and tables are stored in the memory 11000, but those programs and tables may be stored in the storage device 12000 or other recording media (not shown). In this case, the processor 15000, when executing programs, reads the above-mentioned programs and tables on the memory 11000, and executes the read programs.

Moreover, the above-mentioned programs and tables may be stored in the memory 31000 of the host 30000 or the memory 21000 of the storage system 20000, and the host 30000 or the storage system 20000 may execute the stored programs. Moreover, other devices such as other servers (not shown) and fibre channel switches (not shown) may store the above-mentioned programs and tables, and may execute the stored programs.

FIG. 15 describes an example of the task management table 115110 stored in the system management repository 11500 according to the second embodiment of this invention.

The task management table 115110 stores, for respective tasks, information on an execution object, contents of processing, and resources related to the tasks, and task status. As a result of the execution of the task management program 11100, a record is added to the task management table 115110.

The task management table 115110 contains task identifiers 115111, task types 115112, task execution factors 115113, task-related resources (logical volumes) 115114, task-related resources (physical disks) 115115, and task statuses 115116.

The task identifier 115111 stores an identifier used for uniquely identifying a task. The task type 115112 stores a type of the task. The task execution factor 115113 stores an index and a value of the index which causes the execution of the task corresponding to the task identifier 115111.

The task-related resource (logical volume) 115114 stores logical volume numbers for uniquely identifying logical volumes 22100 related to the task corresponding to the task identifier 115111. The task-related resource (physical disk) 115115 stores physical disk numbers for uniquely identifying physical disks 22200 related to the task corresponding to the task identifier 115111.

The task status 115116 stores information representing an execution status of the task. Specifically, the task status 115116 stores any one of “Processing”, “Ready”, and “Waiting”. “Processing” represents a status in which the task corresponding to the task identifier 115111 is being executed, “Ready” represents a status in which the task corresponding to the task identifier 115111 is ready for execution, and “Waiting” represents a status in which execution of the task corresponding to the task identifier 115111 is temporarily suspended.

According to the second embodiment, when a task is completed, entries corresponding to the completed task are deleted from the task management table 115110 and the migration management table 11540.

According to the second embodiment, as the task-related resources, the logical volumes 22100 and the physical disks 22200 are described, but this invention is not limited thereto. For example, the task-related resources may include a host 30000 using a logical volume 22100, and a switch (not shown) or a data I/F 26000 of the storage system 20000 through which data passes when the host 30000 writes the data to the logical volume 22100.

Moreover, the task-related resources may include a resource for holding information on setting and information on set status between logical volumes 22100, such as information on copy and backup.

A description is now given of task management processing carried out by respective programs on the management server 10000. Steps 1001 and 1002 are the same as those of the first embodiment, and hence description thereof is omitted. A description is now given of Steps 1003 and 1004 focusing on differences from the first embodiment.

FIG. 16 is a flowchart detailing the processing (Step 1003) carried out to investigate the relationships between the new task and the planned tasks by the inter-task relationship extraction program 11210 stored in the management server 10000 according to the second embodiment of this invention.

First, the inter-task relationship extraction program 11210 acquires the task execution factor 115113 of the new task from the task management table 115110 (Step 100311).

Then, the inter-task relationship extraction program 11210 carries out the following processing for respective records in the task management table 115110 (Step 100312). Specifically, an arbitrary record is selected from the task management table 115110, and, for the selected task, the following processing is carried out.

First, the inter-task relationship extraction program 11210 acquires the task execution factor 115113 of the selected task from the task management table 115110 (Step 100313).

Then, the inter-task relationship extraction program 11210 determines whether the task execution factor 115113 of the new task and the task execution factor 115113 of the selected task are the same (Step 100314).

For this determination, the inter-task relationship extraction program 11210 may determine that the task execution factor 115113 of the new task and the task execution factor 115113 of the selected task are the same when indices causing the execution of the tasks and the values of the indices are the same, or when the indices causing the execution of the tasks are the same.

When the inter-task relationship extraction program 11210 determines that the task execution factor 115113 of the new task and the task execution factor 115113 of the selected task are the same, the inter-task relationship extraction program 11210 sets the task status 115116 of the new task to “Waiting” (Step 100316), and finishes the processing.

As a result, the execution of the new task is temporarily suspended. This is because the execution of the task having the same task execution factor 115113 as that of the new task has already solved the task execution factor 115113 of the new task.

In Step 100314, when the inter-task relationship extraction program 11210 determines that the task execution factor 115113 of the new task and the task execution factor 115113 of the selected task are not the same, the inter-task relationship extraction program 11210 sets the task status 115116 of the new task to “Ready” (Step 100315), and proceeds to Step 100317.

The inter-task relationship extraction program 11210 determines whether all the records have been processed in the task management table 115110 (Step 100317).

When the inter-task relationship extraction program 11210 determines that not all the records have been processed in the task management table 115110, the inter-task relationship extraction program 11210 returns to Step 100312, and carries out the processing from Step 100312 to Step 100317.

When the inter-task relationship extraction program 11210 determines that all the records have been processed in the task management table 115110, the inter-task relationship extraction program 11210 transmits a request for executing the new task to the task execution program 21300 (Step 100318), and finishes the processing.

FIG. 17 is a flowchart detailing the processing (Step 1004) carried out to determine by the task execution determination program 11310 stored in the management server 10000 whether or not the new task is to be executed according to the second embodiment of this invention.

The task execution determination program 11310 receives a notification of the task completion from the task execution program 21300 of the storage system 20000 (Step 100411). This task is specifically a task having the task status 115116 of “Processing”.

Then, the task execution determination program 11310 carries out the following processing for respective records in the task management table 115110 (Step 100412). Specifically, an arbitrary record is selected from the task management table 115110, and, for the selected task, the following processing is carried out.

First, the task execution determination program 11310 refers to the task management table 115110, and determines whether the task status 115116 of the selected task is “Waiting” (referred to as “task in waiting status” hereinafter) (Step 100413).

When the task execution determination program 11310 determines that the selected task is not a task in waiting status, the task execution determination program 11310 proceeds to Step 100420.

In Step 100413, when the task execution determination program 11310 determines that the selected task is a task in waiting status, the task execution determination program 11310 acquires the related resources of the task in waiting status (task-related resource (logical volume) 115114 and task-related resource (physical disk) 115115 in this case) from the task management table 115110 (Step 100414).

Then, the task execution determination program 11310, by referring to the acquired related resources of the task in waiting status, acquires performance information (resource performances (IOPSes) 11533 in this case) and performance thresholds (resource performance thresholds 11534 in this case) of the respective related resources of the task in waiting status from the performance information table 11530 (Step 100415).

Then, the task execution determination program 11310 compares the acquired performance information (resource performance (IOPS) 11533 in this case) and performance thresholds (resource performance threshold 11534 in this case) of the respective related resources of the task in waiting status, thereby determining whether the acquired performance information of the respective related resources of the task in waiting status satisfies the acquired performance thresholds of the respective related resources of the task in waiting status (Step 100416).

When the task execution determination program 11310 determines that the acquired performance information of the respective related resources of the task in waiting status satisfies the acquired performance thresholds of the respective related resources of the task in waiting status, the task execution determination program 11310 deletes the records corresponding to the task in waiting status from the task management table 115110 and the migration management table 11540 (Step 100419), and finishes the processing.

In Step 100416, when the task execution determination program 11310 determines that the acquired performance information of the respective related resources of the task in waiting status does not satisfy the acquired performance thresholds of the respective related resources of the task in waiting status, the task execution determination program 11310 sets the task status 115116 of the task in waiting status to “Ready” (Step 100417). In other words, the task in waiting status is set as a task ready for execution.

This sets the task in waiting status, which is possibly an unnecessary task from the fact that another task having the same task execution factor 115113 is present in Step 1003, to a task ready for execution.

The task execution determination program 11310 transmits a request for executing the task having the task status 115116 set to “Ready” to the task execution program 21300 (Step 100418).

The task execution determination program 11310 determines whether all the records have been processed in the task management table 115110 (Step 100420).

When the task execution determination program 11310 determines that not all the records have been processed in the task management table 115110, the task execution determination program 11310 returns to Step 100412, and carries out the processing from Step 100412 to Step 100420.

When the task execution determination program 11310 determines that all the records have been processed in the task management table 115110, the task execution determination program 11310 finishes the processing.

According to the second embodiment, “TASK B” is planned as a new task, and has the same task execution factor 115113 as that of “TASK A”. Thus, to the task status 115116 of this new task, “Waiting” is set.

In Step 100416, in the task execution determination program 11310, for the logical volumes 22100 (LV1 and LV3) and the physical disks 22200 (e1 and e2), which are the related resources of “TASK A”, it is found that the performance values of the related resources after the migration from the logical volume 22100 (LV1) to the logical volume 22100 (LV3) satisfy the performance thresholds of the related resources of “TASK B”, which is a new task. As a result, the task execution determination program 11310 can eliminate “TASK B” as an unnecessary task.

It should be noted that the determination method in Step 100416 may employ the same method as the simulation according to the first embodiment.

According to the second embodiment of this invention, by associating a task execution factor of a task, resources related to the task in terms of configuration or setting and the execution status of the task, as additional information, with the task, thereby managing the task associated with the additional information, the management server 10000 can determine, by checking again the performance information of the storage system 20000 upon start of a task which has the same task execution factor 115113, and cannot be executed simultaneously, whether or not the execution of the new task is necessary. As a result, it is possible to eliminate an unnecessary task.

From a different point of view, the management server 10000 need not carry out the simulation and the like for tasks which are not related to the new task, and hence it is possible to reduce processing compared with the first embodiment.

### Third Embodiment

A description is now given of a third embodiment of this invention. The following description mainly focuses on differences from the first embodiment of this invention.

A configuration of the SAN, a configuration of the storage system 20000, and a configuration of the host 30000 according to the third embodiment of this invention are respectively the same as those illustrated in FIGS. 1, 3, and 4 according to the first embodiment, and hence description thereof is omitted.

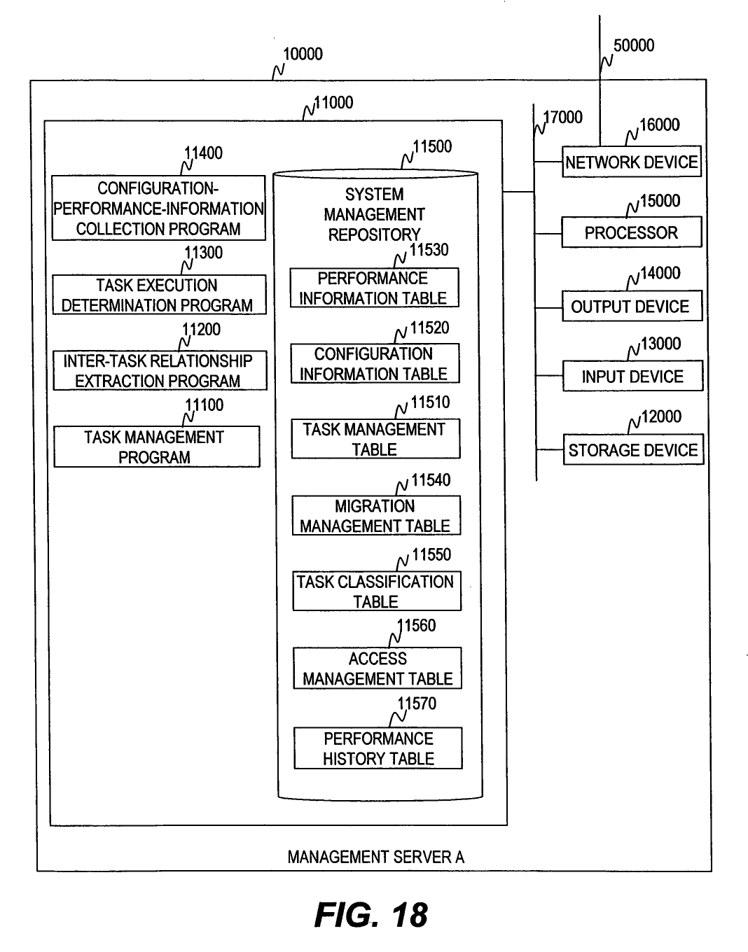

FIG. 18 is a block diagram illustrating an example of the configuration of the management server 10000 according to the third embodiment of this invention.

The management server 10000 includes a memory 11000, a storage device 12000, an input device 13000, an output device 14000, a processor 15000, and a network device 16000, and those components are coupled with each other via a communication line 170000 such as an internal bus.

The memory 11000 stores a task management program 11130, an inter-task relationship extraction program 11200, a task execution determination program 11330, a configuration/performance information collection program 11400, and a system management repository 11500.

The system management repository 11500 stores a task management table 115130, a configuration information table 11520, a performance information table 11530, a migration management table 11540, a task classification table 11550, an access management table 11560, and a performance history table 11570.

The task management table 115130 stores information on task types, task execution factors, and resources related to the tasks, time of planning the tasks, and planned start time of the tasks. The configuration information table 11520 stores configuration information on the SAN. The performance information table 11530 stores devices coupled to the SAN, and performance information on resources in the devices. The migration management table 11540 stores information on migration processing. The task classification table 11550 stores priorities of tasks.

The access management table 11560 stores information on access denial processing. The performance history table 11570 stores history of the devices coupled to the SAN, and the performance information on the resources in the devices.

The storage device 12000 is an HDD or the like for storing information. The input device 13000 is a keyboard or the like used by a SAN administrator to input instructions to the task management program 11130. The output device 14000 is a display device for outputting an execution result of processing carried out by the task execution program 21300. The processor 15000 executes programs loaded on the memory 11000. The network device 16000 is a device used to couple to a management network 50000.

The storage device 12000, the input device 13000, the output device 14000, the processor 15000, and the network device 16000 are the same as those of the first embodiment.

In the example illustrated in FIG. 18, the above-mentioned programs and tables are stored in the memory 11000, but those programs and tables may be stored in the storage device 12000 or other recording media (not shown). In this case, the processor 15000, when executing programs, reads the above-mentioned programs and tables on the memory 11000, and executes the read programs.

Moreover, the above-mentioned programs and tables may be stored in a memory 31000 of the host 30000 or a memory 21000 of the storage system 20000, and the host 30000 or the storage system 20000 may execute the stored programs. Moreover, other devices such as other servers (not shown) and fibre channel switches (not shown) may store the above-mentioned programs and tables, and may execute the stored programs.

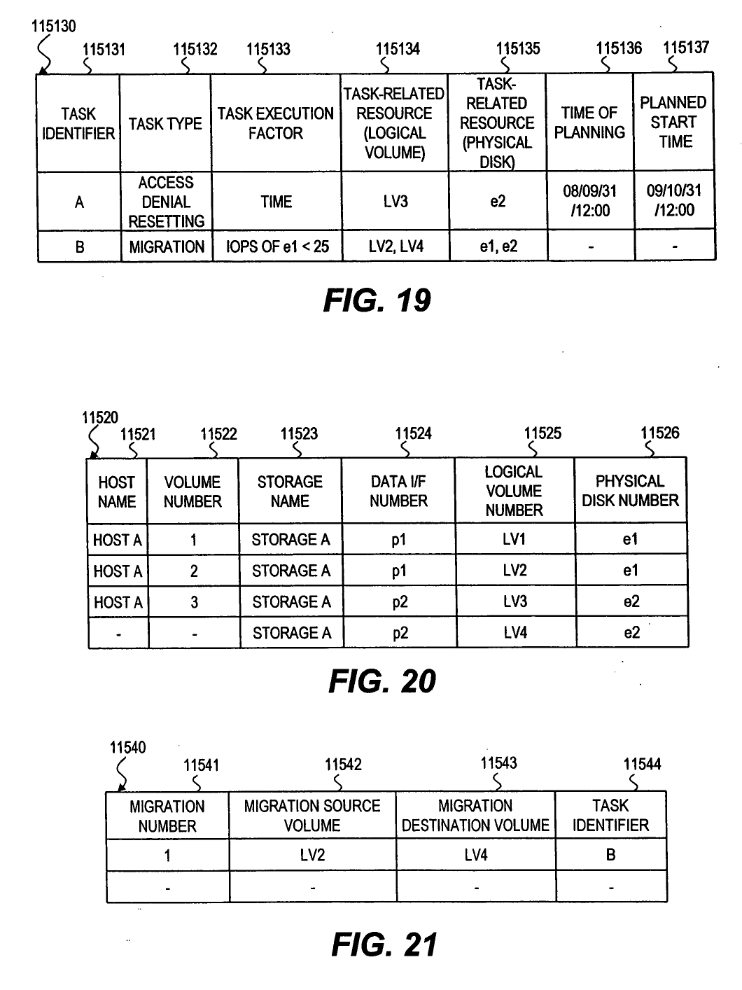

FIG. 19 describes an example of the task management table 115130 stored in the system management repository 11500 according to the third embodiment of this invention.

The task management table 115130 stores, for respective tasks, information on an execution object, contents of processing, and resources related to the tasks, time of planning the tasks, and planned start time of the tasks. As a result of the execution of the task management program 11130, a record is added to the task management table 115130.

The task management table 115130 contains task identifiers 115131, task types 115132, task execution factors 115133, task-related resources (logical volumes) 115134, task-related resources (physical disks) 115135, time of planning 115136, and planned start time 115137.

The task identifier 115131 stores an identifier used for uniquely identifying a task. The task type 115132 stores a type of the task. The task execution factor 115133 stores an index and a value of the index which causes the execution of the task corresponding to the task identifier 115131.

The task-related resource (logical volume) 115134 stores logical volume numbers for uniquely identifying logical volumes 22100 related to the task corresponding to the task identifier 115131. The task-related resource (physical disk) 115135 stores physical disk numbers for uniquely identifying physical disks 22200 related to the task corresponding to the task identifier 115131.

The time of planning 115136 stores time at which execution of the task corresponding to the task identifier 115131 has been planned. The planned start time 115137 stores time at which the execution of the task corresponding to the task identifier 115131 starts.

It should be noted that a record containing the time of planning 115136 and the planned start time 115137 having “-” represents a task which is executed immediately, or has the start time not particularly specified.

According to the third embodiment, as the task-related resources, the logical volumes 22100 and the physical disks 22200 are described, but this invention is not limited thereto. For example, the task-related resources may include a host 30000 using a logical volume 22100, and a switch (not shown) or a data I/F 26000 of the storage system 20000 through which data passes when the host 30000 writes the data to the logical volume 22100.

Moreover, the task-related resources may include a resource for holding information on setting and information on set status between logical volumes 22100, such as information on copy and backup.

The configuration information table 11520, the performance information table 11530, the migration management table 11540, and the task classification table 11550 stored in the system management repository 11500 are the same as those illustrated in FIGS. 6, 7, 8, and 9 according to the first embodiment, but as examples according to the third embodiment, the configuration information table 11520 and the migration management table 11540 are described.

FIG. 20 describes an example of the configuration information table 11520 stored in the system management repository 11500 according to the third embodiment of this invention. FIG. 21 describes an example of the migration management table 11540 stored in the system management repository 11500 according to the third embodiment of this invention. The configurations of the respective tables are the same as those according to the first embodiment, and hence description thereof is omitted.

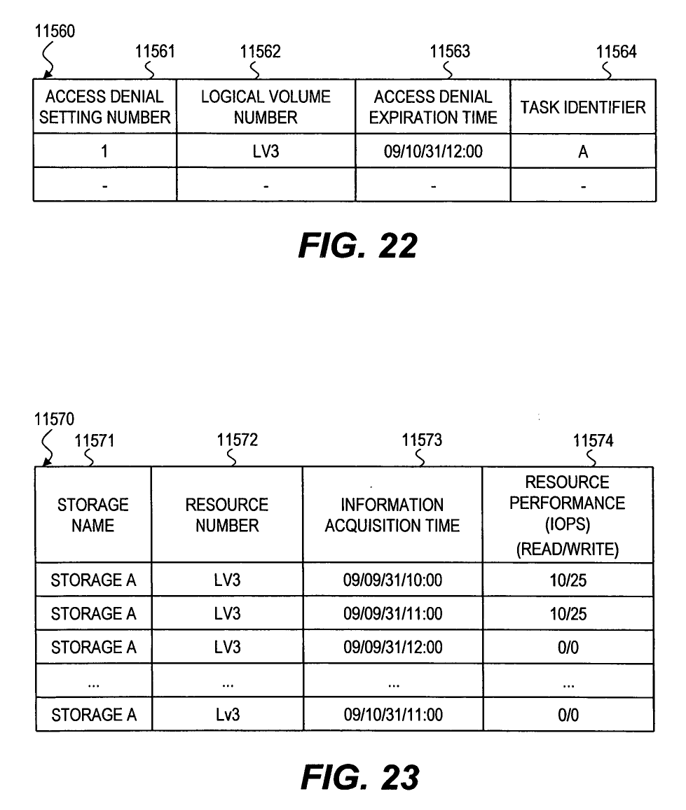

FIG. 22 describes an example of the access management table 11560 stored in the system management repository 11500 according to the third embodiment of this invention.

The access management table 11560 stores information necessary when the task execution program 21300 stored in the storage system 20000 resets the access denial of a logical volume 22100 to which access denial processing has been carried out. As a result of the execution of the task management program 11130, a record is added to the access management table 11560.

The access management table 11560 includes access denial setting numbers 11561, logical volume numbers 11562, access denial expiration time 11563, and task identifiers 11564.

The access denial setting number 11561 stores an identifier used for uniquely identifying access denial setting. The logical volume number 11562 stores a logical volume number for uniquely identifying a logical volume 22100 subject to the access denial setting.

The access denial expiration time 11563 stores information representing an expiration time of the access denial. The task identifier 11564 stores an identifier used for uniquely identifying a task.

According to the third embodiment, the migration and the access denial resetting are considered as examples of the task, and hence the management server 10000 includes the migration management table 11540 and the access management table 11560, but this invention is not limited to this configuration. For example, the management server 10000 may manage other functions such as copying and path setting as the task, and may include management tables corresponding to the respective functions.

FIG. 23 describes an example of the performance history table 11570 stored in the system management repository 11500 according to the third embodiment of this invention.

The performance history table 11570 stores history of performance information of the SAN components such as the logical volumes 22100 and the physical disks 22200 of the storage system 20000. As a result of execution of the configuration/performance information collection program 11400, a record is added to the performance history table 11570.

The management server 10000 according to the third embodiment independently stores the performance information table 11530 and the performance history table 11570, but this invention is not limited to this configuration. For example, the management server 10000 may store the performance information table 11530 containing the history information.

The performance history table 11570 contains storage names 11571, resource numbers 11572, information acquisition times 11573, and resource performances (IOPS) (Read/Write) 11574.

The storage name 11571 stores an identifier used for uniquely identifying a storage system 20000. The resource number 11572 stores a logical volume number or a physical disk number used for uniquely identifying a logical volume 22100 or a physical disk 22200 in the storage system 20000 corresponding to the storage name 11571.

The information acquisition time 11573 stores a time when performance information is acquired. The resource performance (IOPS) (Read/Write) 11574 stores the respective numbers of Read I/O operations and Write I/O operations per unit time (one second according to the third embodiment) with respect to the logical volume 22100 or the physical disk 22200 corresponding to the resource number 11572.

According to the third embodiment, the Read IO Per Second and the Write IO Per Second are used as the performance information on the resources, but other types of performance information such as IO Response Time, and Transfer Rate may be used.

A description is now given of task management processing carried out by respective programs on the management server 10000. Steps 1001 and 1003 are the same as those of the first embodiment, and hence description thereof is omitted. A description is now given of Steps 1002 and 1004 focusing on differences from the first embodiment.

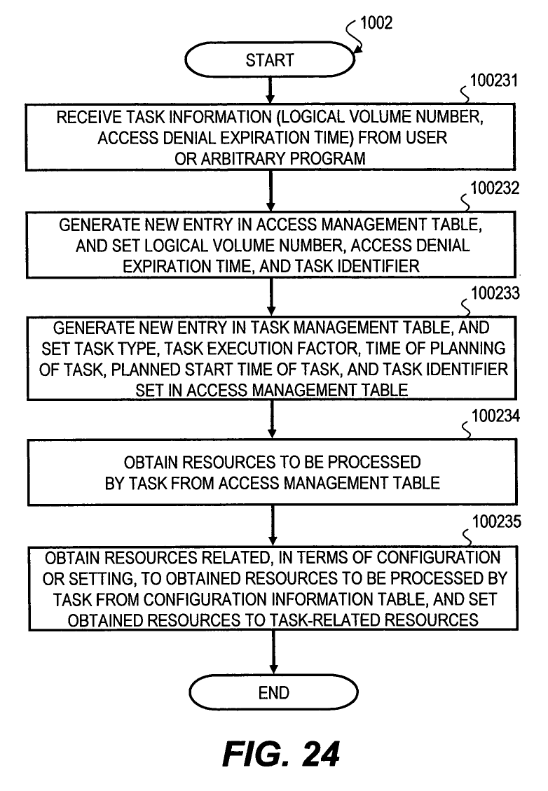

FIG. 24 is a flowchart detailing the processing (Step 1002) carried out to register the new task to the task management table 115130 by the task management program 11130 stored in the management server 10000 according to the third embodiment of this invention. In this flowchart, the description is given of the case in which the access denial processing is planned as a task.

The task management program 11130 receives task information from a user or an arbitrary program (Step 100231). This task information contains a logical volume number and an expiration time of access denial.

The task management program 11130, based on the received task information, creates a new entry in the access management table 11560, and sets the access denial setting number 11561, the logical volume number 11562, the access denial expiration time 11563, and the task identifier 11564 (Step 100232).

The task management program 11130, based on the received task information, creates a new entry in the task management table 115130, and sets the task type 115132, the task execution factor 115133, the time of planning 115136, the planned start time 115137 and the task identifier 115131 (Step 100233). It should be noted that, to the task identifier 115131, the same identifier as the task identifier 11564 in the access management table 11560 is set.

According to the third embodiment, the task management program 11130 sets the time which is acquired by the management server 10000, and at which the processing in Step 100233 starts as the time of planning 115136, but this invention is not limited to this configuration. For example, the management server 10000 may acquire time information from a time management server (not shown) common to the storage system 20000, and the task management program 11130 may set the acquired time information to the time of planning 115136.

Moreover, according to the third embodiment, the expiration time of access denial acquired by the management server 10000 is set to the planned start time 115137, but this invention is not limited to this configuration. For example, for processing which does not hold information corresponding to the planned start time 115137, similarly to the case in which the task execution factor 11513 is registered according to the first embodiment as illustrated in FIG. 11, the task management program 11130 sets information acquired from the program which has transmitted the task, or information acquired from a user input to the planned start time 115137.

Then, the task management program 11130 refers to the logical volume number 11562 in the access management table 11560, thereby acquiring resources to be processed by the task (Step 100234).

The task management program 11130 acquires resources related in terms of configuration or setting to the acquired resources to be processed by the task from the configuration information table 11520, sets the acquired resources to the task-related resources 115134 and 115135 of the task management table 115130 (Step 100235), and finishes the processing.

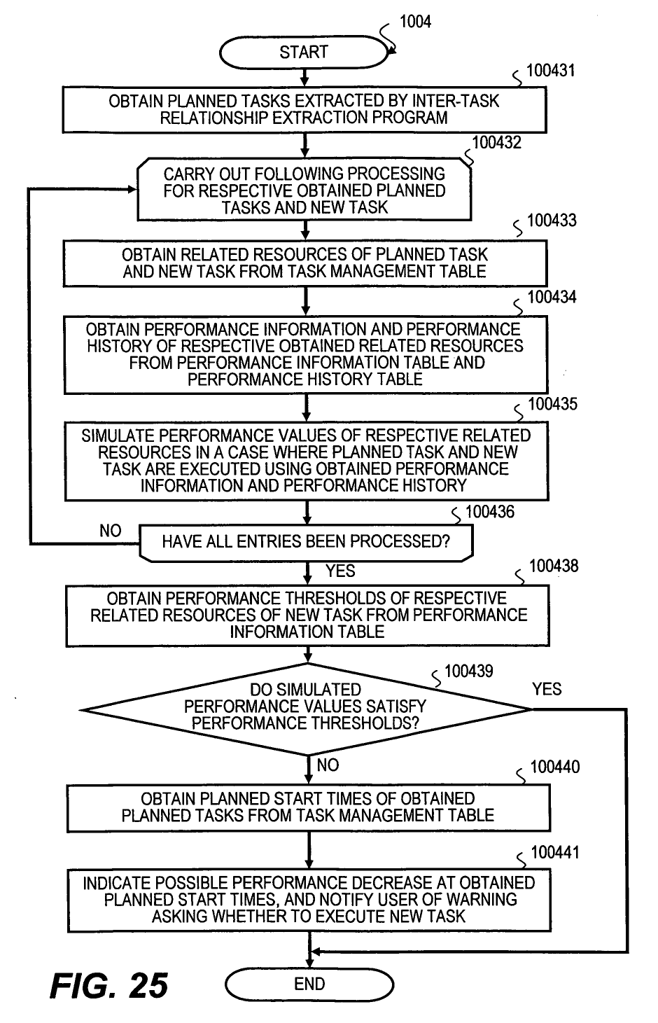

FIG. 25 is a flowchart detailing the processing (Step 1004) carried out to determine by the task execution determination program 11330 stored in the management server 10000 whether or not the new task is to be executed according to the third embodiment of this invention.

First, the task execution determination program 11330 acquires the planned tasks extracted by the execution of the inter-task relationship extraction program 11200 (Step 100431).

Then, the task execution determination program 11330 carries out the following processing for the respective acquired planned tasks and the new task (Step 100432).

The task execution determination program 11330 refers to information related to the respective acquired planned tasks and the new task (task identifiers 11544 and 11564 in this case), and acquires related resources of the planned tasks and the new task (task-related resources (logical volumes) 115134 and task-related resources (physical disks) 115135 in this case) from the task management table 115130 (Step 100433).

Then, the task execution determination program 11330 refers to the acquired related resources, acquires performance information (resource performance (IOPS) 11533 and resource performance thresholds 11534 in this case) on the acquired related resources from the performance information table 11530, and acquires performance information on the acquired related resources (resource performance (IOPS) (Read/Write) 11574 in this case) from the performance history table 11570 (Step 100434).

The task execution determination program 11330, based on the performance information on the acquired related resources, simulates the performance values of the respective related resources after the planned task and the new task are executed (Step 100435).

The task execution determination program 11330 determines whether all the acquired planned tasks have been processed (Step 100436).

When the task execution determination program 11330 determines that not all the acquired planned tasks have been processed, the task execution determination program 11330 returns to Step 100432, and carries out the processing from Step 100432 to Step 100436.

When the task execution determination program 11330 determines that the processing has been carried out for all the acquired planned tasks, the task execution determination program 11330 refers to the acquired related resources of the new task, thereby acquiring performance thresholds (resource performance threshold 11534 in this case) of the acquired related resources of the new task from the performance information table 11530 (Step 100438).

The task execution determination program 11330 determines, for all the acquired related resources of the new task, whether the simulated performance values satisfy the corresponding performance thresholds of the acquired related resources of the new task (Step 100439).

When the task execution determination program 11330 determines that the simulated performance values do not satisfy the performance thresholds of the acquired related resources of the new task, the task execution determination program 11330 acquires planned start times 115137 of the acquired planned tasks from the task management table 115130 (Step 100440), indicates a possible performance decrease at the acquired planned start times 115137, notifies the user of warning asking whether to execute the new task (Step 100441), and finishes the processing.

When the task execution determination program 11330 determines that the simulated performance values satisfy the acquired performance thresholds of the related resources of the new task, the task execution determination program 11330 finishes the processing.

According to the third embodiment, “TASK B” is planned as the new task, and “TASK A” is extracted as the planned task related to the new task.

The task execution determination program 11330, for the logical volume 22100 (LV3) and the physical disk 22200 (e2), which are the related resources of “TASK A”, by simulating the performance values after the access denial is reset, can predict that the IOPS of the logical volume 22100 (LV3) becomes from 10 to 35, and the IOPS of the physical disk 22200 (e2) becomes from 10 to 35.

The simulation is carried out by adding the value of the IOPS of the logical volume 22100 as the performance history before the access denial is set as a value of the IOPS added after the access denial is reset, but this invention is not limited to this configuration. The simulation may be carried out by using another method.

The task execution determination program 11330, for the logical volumes 22100 (LV2 and LV4) and the physical disks 22200 (e1 and e2), which are the related resources of “TASK B”, by simulating the performance values after the migration from the logical volume 22100 (LV2) to the logical volume 22100 (LV4), can predict that the IOPS of the logical volume 22100 (LV2) becomes from 20 to 0, the IOPS of the logical volume 22100 (LV4) becomes from 0 to 20, the IOPS of the physical disk 22200 (e1) becomes from 30 to 10, and the IOPS of the physical disk 22200 (e2) becomes from 35 to 55.

The simulation of the migration is the same as that in the first embodiment, and hence description thereof is omitted.

As a result of the simulation, the task execution determination program 11330 recognizes that the performance threshold of the physical disk 22200 (e2), which is the related resource of “TASK B” is no longer satisfied, and thus, notifies a user of warning asking whether to execute “TASK B”. As a result, “TASK B” is presented as an unnecessary task.

According to the third embodiment of this invention, by associating, as additional information, an execution factor of a task and resources related to the task in terms of configuration or setting with the task, thereby managing the task associated with the additional information, the management server 10000 can determine, by simulating a result including influence of a task to be executed after the task of interest, the necessity of the task execution.

Moreover, as a result of the simulation, when the task execution is not necessary, it is possible to notify a user of warning that the execution of the task is not necessary, thereby eliminating the unnecessary task.

### Fourth Embodiment

A description is now given of a fourth embodiment of this invention. The following description mainly focuses on differences from the first embodiment of this invention.

First, a description is given of a configuration of a SAN in the fourth embodiment.

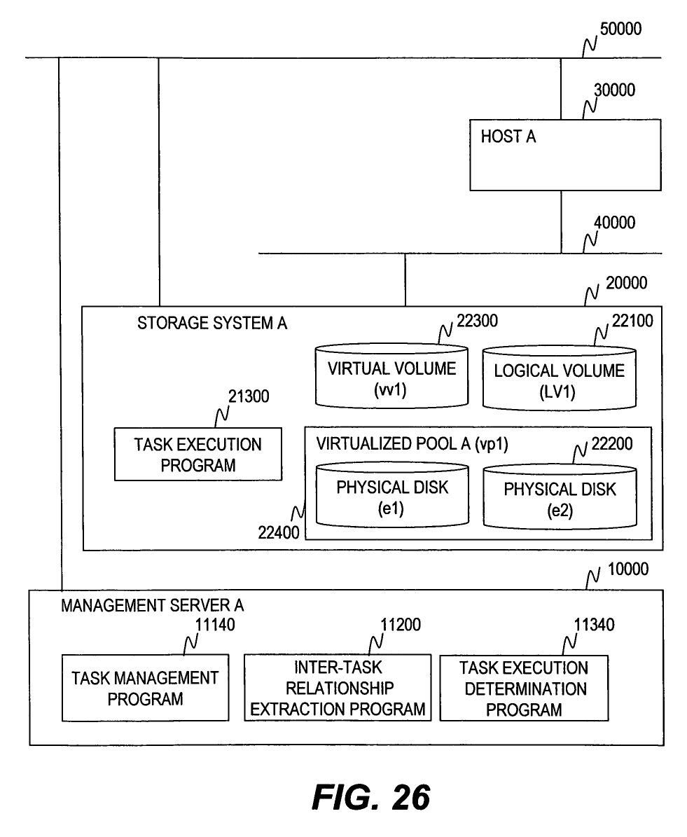

FIG. 26 is a block diagram illustrating an example of the configuration of the SAN according to the fourth embodiment of this invention.

The SAN according to the fourth embodiment includes at least one host 30000, at least one storage system 20000, and at least one management server 10000.

The storage system 20000 stores a task execution program 21300. The task execution program 21300 is a program for realizing functions provided by the storage system 20000.

The storage system 20000 includes a plurality of physical disks 22200 (e1 and e2), and a virtualized pool 22400 (vp1) constituted by the plurality of physical disks 22200.

On the storage system 20000, a plurality of logical volumes 22100 and a plurality of virtual volumes 22300 are created, and the created logical volumes 22100 and virtual volumes 22300 are provided to the host 30000.

In the example illustrated in FIG. 26, the storage system 20000 (storage system A) provides the host 30000 (host A) with a logical volume 22100 (LV1) and a virtual volume 22300 (vv1).

Each processing in the fourth embodiment is executed only in the configuration of the SAN including the storage system 20000 including the virtual volume 22300, but may be executed in the configuration of the SAN illustrated in FIG. 1.

The management server 10000 stores a task management program 11140, an inter-task relationship extraction program 11200, and a task execution determination program 11340.

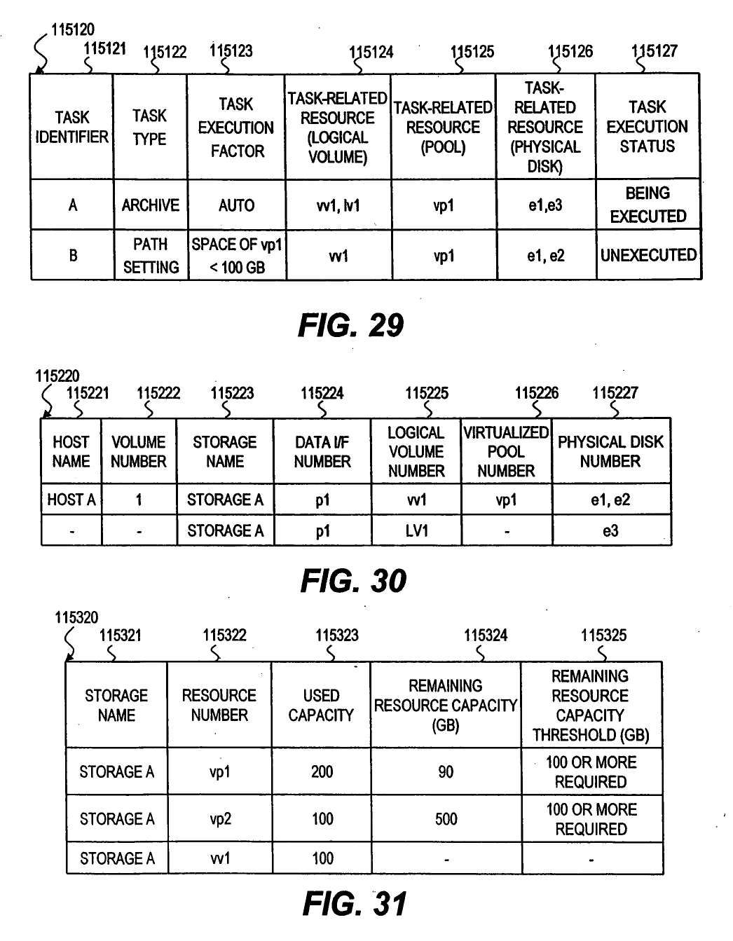

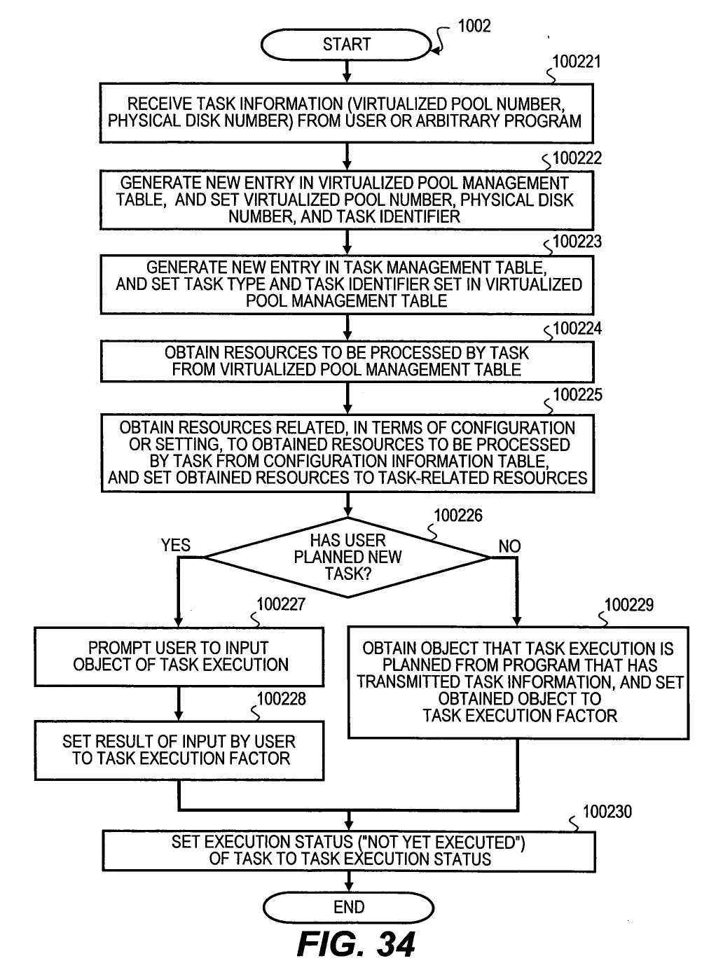

The task management program 11140 is a program for creating a task management table 115120 illustrated in FIG. 29. A detailed description is later given of processing of the task management program 11140 referring to FIG. 34.

The inter-task relationship extraction program 11200 is a program for investigating relationships between a newly planned task and other tasks already planned. Processing of the inter-task relationship extraction program 11200 is the same as that of the first embodiment.

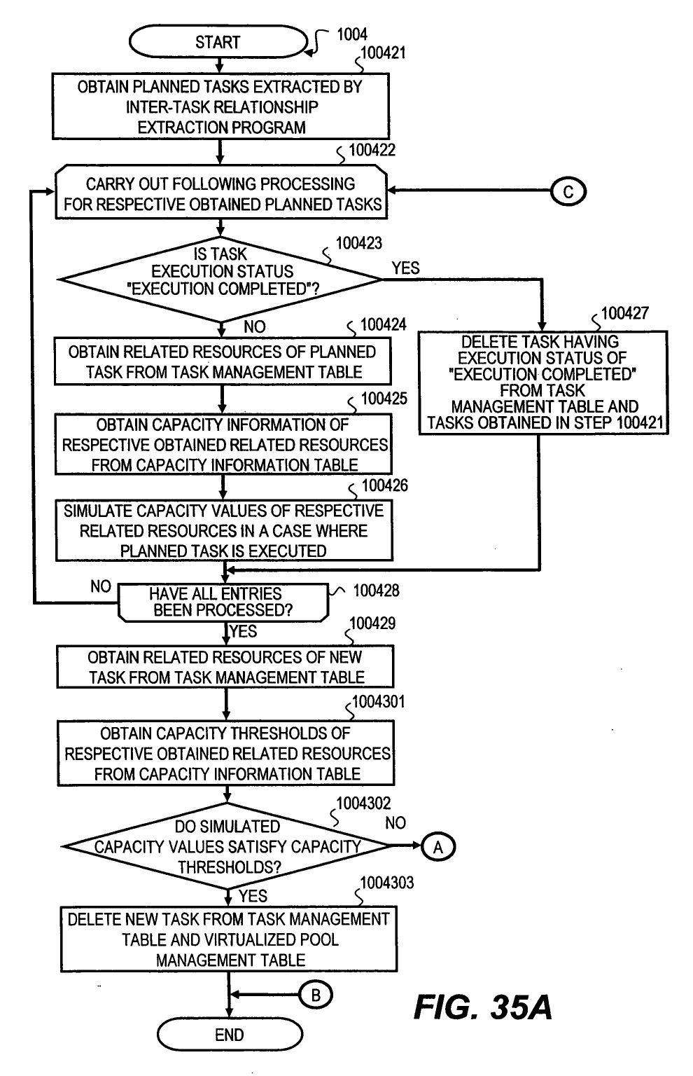

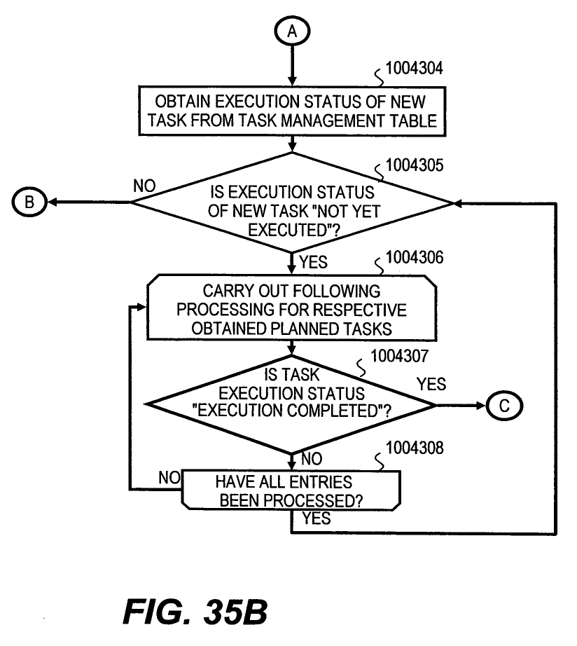

The task execution determination program 11340 is a program for determining whether or not a newly planned task is to be executed. A detailed description is later given of processing of the task execution determination program 11340 referring to FIG. 35.

The host 30000 carries out various business tasks by using the logical volumes 22100 and virtual volumes 22300 provided by the storage system 20000.

The host 30000 (host A) and the storage system 20000 (storage system A) are coupled with each other via a fibre channel 40000.

The management server 10000 (management server A) is coupled to the storage system 20000 (storage system A) and the host 30000 (host A) via a management network 50000. The management server 10000 (management server A) can communicate with the task execution program 21300 via the management network 50000.

In the example illustrated in FIG. 26, the management server 10000 stores the task management program 11140, the inter-task relationship extraction program 11200, and the task execution determination program 11340, but this invention is not limited to this configuration. For example, the storage system 20000 or the host 30000 may store those programs. Moreover, other devices such as switches (not shown) provided between the respective devices may store the above-mentioned programs.

Moreover, the storage system 20000 stores the task execution program 21300, but this invention is not limited to this configuration. For example, the management server 10000 or the host 30000 may store the task execution program 21300. Moreover, other devices such as switches (not shown) provided between the respective devices may store the task execution program 21300.

Moreover, the coupling between the host 30000 (host A) and the storage system 20000 (storage system A) is not limited to the direct coupling via the fibre channel 40000, and may be interposed by at least one network device such as a fiber channel switch. Moreover, the coupling between the host 30000 (host A) and the storage system 20000 (storage system A) may be any network for data communication such as an IP network.

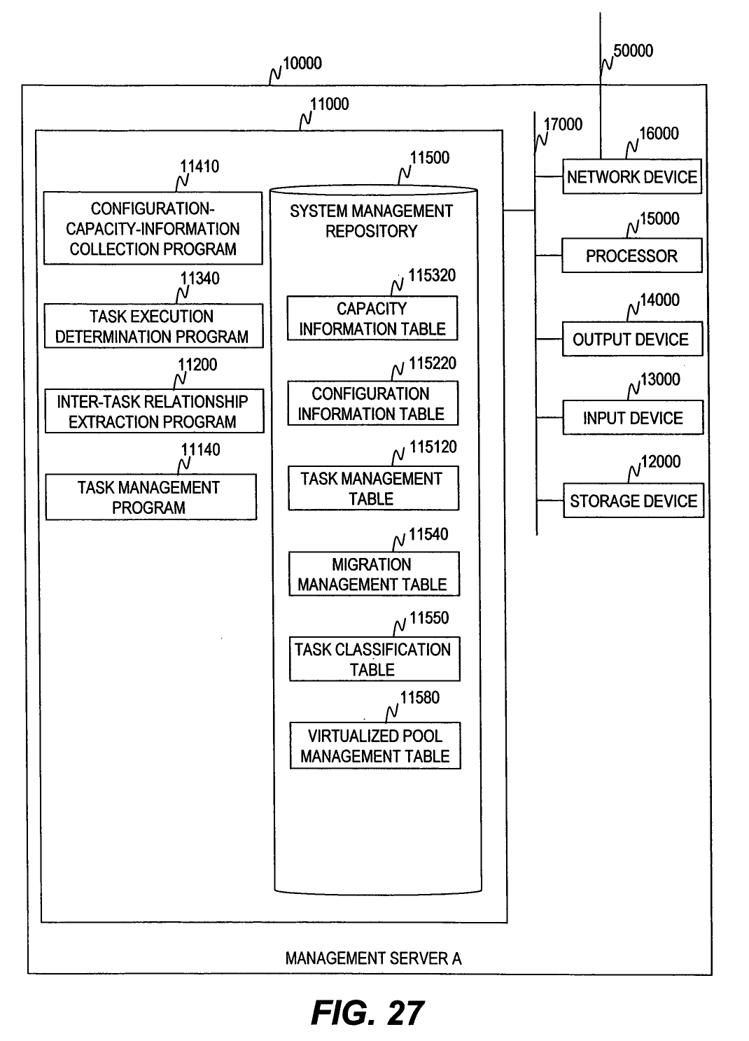

FIG. 27 is a block diagram illustrating an example of the configuration of the management server 10000 according to the fourth embodiment of this invention.

The management server 10000 includes a memory 11000, a storage device 12000, an input device 13000, an output device 14000, a processor 15000, and a network device 16000, and those components are coupled with each other via a communication line 17000 such as an internal bus.

The memory 11000 stores the task management program 11140, the inter-task relationship extraction program 11200, the task execution determination program 11340, a configuration/capacity information collection program 11410, and a system management repository 11500.

The configuration/capacity information collection program 11410 is the same as the configuration/performance information collection program 11400 in the first embodiment, but the configuration/capacity information collection program 11410 collects, in place of collecting the performance information, information on capacity of the logical volume 22100 and the like.

The system management repository 11500 stores the task management table 115120, a configuration information table 115220, a capacity information table 115320, a migration management table 11540, a task classification table 11550 and a virtualized pool management table 11580.

The task management table 115120 stores information on task types, task execution factors, and resources related to the tasks. The configuration information table 115220 stores configuration information on the SAN. The capacity information table 115320 stores devices coupled to the SAN, and capacity information on resources in the devices.

The migration management table 11540 stores information on migration processing. The task classification table 11550 stores priorities of tasks. The virtualized pool management table 11580 stores information on the virtualized pool 22400.

The storage device 12000 is an HDD or the like for storing information. The input device 13000 is a keyboard or the like used by a SAN administrator to input instructions to the task management program 11140. The output device 14000 is a display device for outputting an execution result of processing carried out by the task execution program 21300. The processor 15000 executes programs loaded on the memory 11000. The network device 16000 is a device used to couple to the management network 50000.

In the example illustrated in FIG. 27, the above-mentioned programs and tables are stored in the memory 11000, but those programs and tables may be stored in the storage device 12000 or other recording media (not shown). In this case, the processor 15000, when executing programs, reads the above-mentioned programs and tables on the memory 11000, and executes the read programs.

Moreover, the above-mentioned programs and tables may be stored in a memory 31000 of the host 30000 illustrated in FIG. 4 or a memory 21000 of the storage system 20000 illustrated in FIG. 3, and the host 30000 or the storage system 20000 may execute the stored programs. Moreover, other devices such as other servers (not shown) and fibre channel switches (not shown) may store the above-mentioned programs and tables, and may execute the stored programs.

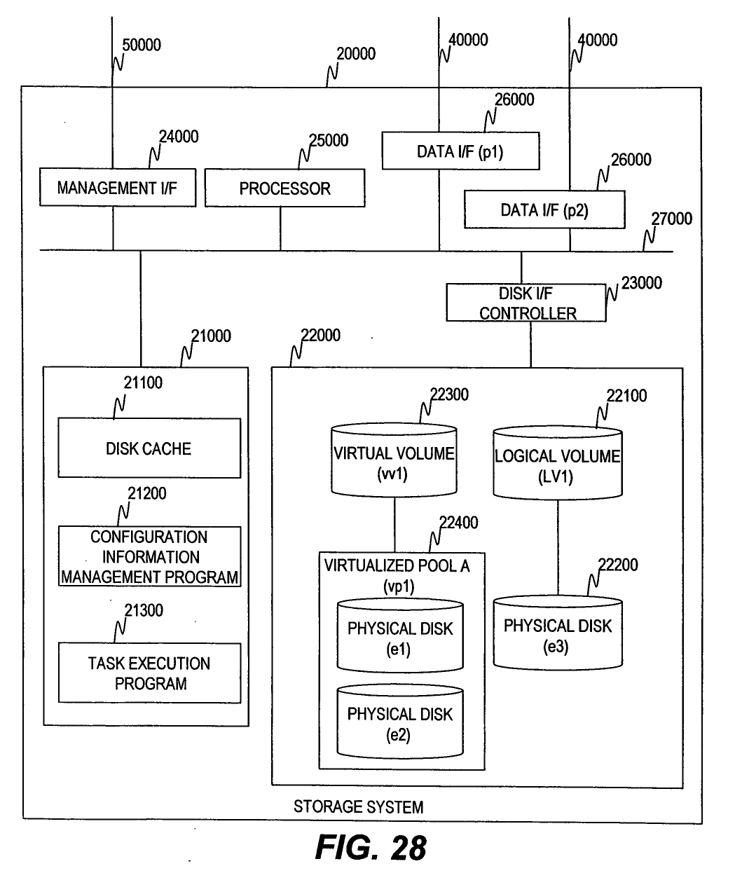

FIG. 28 is a block diagram illustrating an example of the configuration of the storage system 20000 according to the fourth embodiment of this invention.

The storage system 20000 includes the memory 21000, a logical volume providing unit 22000, a disk I/F controller 23000, a management I/F 24000, a processor 25000, and a data I/F 26000, and those components are coupled with each other via a communication line 27000 such as an internal bus.

The memory 21000 stores a disk cache 21100, a configuration information management program 21200, and the task execution program 21300.

The disk cache 21100 is a storage volume for temporarily storing information. The configuration information management program 21200 is a program for transmitting and receiving management information and performance/capacity information on the storage system 20000 to/from the management server 10000. The task execution program 21300 is a program for executing functions provided by the storage system 20000.

The logical volume providing unit 22000 includes a physical disk 22200. The logical volume providing unit 22000 logically divides a storage volume of the physical disk 22200, and provides the logically divided storage volume as a logical volume 22100. As a result, an access to the logical volume 22100 and the virtual volume 22300 from the outside of the storage system 20000 is enabled.

Moreover, the logical volume providing unit 22000 logically divides a storage volume of the virtualized pool 22400 constituted by the plurality of physical disks 22200, and provides the divided storage volume as a virtual volume 22300. As a result, a user of the host 30000 can define a volume having an arbitrary capacity as a virtual volume 22300, and can make access to a storage volume in the virtualized pool 22400 via the virtual volume 22300.

It should be noted that a physical disk number is assigned to the physical disk 22200, a logical volume number is assigned to the logical volume 22100, a virtual volume number is assigned to the virtual volume 22300, and a virtualized pool number is assigned to the virtualized pool 22400. As a result, the storage system 20000 can uniquely identify the respective physical disks 22200, logical volumes 22100, and virtual volumes 22300.

In the example illustrated in FIG. 28, it is found that the storage system 20000 includes three physical disks 22200 having the physical disk numbers of “e1”, “e2”, and “e3”, one logical volume 22100 having the logical volume number of “LV1”, one virtual volume 22300 having the virtual volume number of “vv1”, and one virtualized pool 22400 having the virtualized pool number of “vp1”.

The disk I/F controller 23000 is an interface used for coupling to the logical volume providing unit 22000. The management I/F 24000 is an interface used for coupling to the management network 50000. The processor 25000 executes programs loaded on the memory 21000.

The. data I/F 26000 is an interface used for coupling to the fibre channel 40000. It should be noted that a plurality of disk I/F controllers 23000, a plurality of management I/Fs 24000, and a plurality of data I/Fs 26000 may be provided. In the example illustrated in FIG. 28, the storage system 20000 includes two data I/Fs 26000 including a data I/F (p1) and a data I/F (p2).

In the example illustrated in FIG. 28, the above-mentioned programs are stored in the memory 21000, but the programs may be stored in other recording devices (not shown) or other recording media (not shown). In this case, the processor 25000, when carrying out processing, reads the above-mentioned programs on the memory 21000, and executes the read programs.

Moreover, the above-mentioned programs may be stored in the memory 31000 of the host 30000 or the memory 21000 of the storage system 20000, and the host 30000 or the storage system 20000 may execute the stored programs. Moreover, other storage systems (not shown) may store the above-mentioned programs, and may execute the stored programs.

Moreover, the logical volume providing unit 22000 may logically divide a RAID group constituted by a plurality of physical disks 22200, thereby creating logical volumes 22100. Moreover, the logical volume providing unit 22000 may create one logical volume 22100 from an entire storage volume of one physical disk 22200. Moreover, the logical volume providing unit 22000 may create logical volumes 22100 from storage volumes of storage media such as flash memories other than the physical disks 22200.

FIG. 29 describes an example of the task management table 115120 stored in the system management repository 11500 according to the fourth embodiment of this invention.

The task management table 115120 stores, for respective tasks, information on an execution object, contents of processing, and resources related to the tasks, and task execution statuses. As a result of the execution of the task management program 11140, a record is added to the task management table 115120.

The task management table 115120 contains task identifiers 115121, task types 115122, task execution factors 115123, task-related resources (logical volumes) 115124, task-related resources (pools) 115125, task-related resources (physical disks) 115126, and task execution statuses 115127.

The task identifier 115121 stores an identifier used for uniquely identifying a task. The task type 115122 stores a type of the task. The task execution factor 115123 stores an index and a value of the index which causes the execution of the task corresponding to the task identifier 115121.

The task-related resource (logical volume) 115124 stores logical volume numbers or virtual volume numbers for uniquely identifying logical volumes 22100 or virtual volumes 22300 related to the task corresponding to the task identifier 115121.

The task-related resource (pool) 115125 stores virtualized pool numbers for uniquely identifying virtualized pools 22400 related to the task corresponding to the task identifier 115121.

The task-related resource (physical disk) 115126 stores physical disk numbers for uniquely identifying physical disks 22200 related to the task corresponding to the task identifier 115121.

The task execution status 115127 stores an execution status of the task corresponding to the task identifier 115121. Specifically, any one of “Unexecuted”, “Being Executed”, and “Execution Completed” is stored. “Unexecuted” represents a status before the execution of a task, “Being Executed” represents a status during the execution of the task, and “Execution Completed” represents a status after the completion of the task.

When the execution of a task starts, the task management program 11140 receives a notice of the start of the task execution from the task execution program 21300, and sets “Being Executed” to the task execution status 115127. When the execution of the task has been completed, the task management program 11140 receives a notice of the completion of the task execution from the task execution program 21300, and sets “Execution Completed” to the task execution status 115127.

According to the fourth embodiment, as the task-related resources, the logical volumes 22100, the virtual volumes 22300, the virtualized pools 22400 and the physical disks 22200 are described, but this invention is not limited thereto. For example, the task-related resources may include a host 30000 using a logical volume 22100, and a switch (not shown) or a data I/F 26000 of the storage system 20000 through which data passes when the host 30000 writes the data to the logical volume 22100.

Moreover, the task-related resources may include a resource for holding information on setting and information on set status between logical volumes 22100, such as information on copy and backup.

FIG. 30 describes an example of the configuration information table 115220 stored in the system management repository 11500 according to the fourth embodiment of this invention.

The configuration information table 115220 stores information on a path which is used by a host 30000 for making access to a logical volume 22100 or a virtual volume 22300, and extends between the host 30000 and a physical disk 22200 on which the logical volume 22100 or the virtual volume 22300 which is provided to the host 30000 is created. As a result of execution of the configuration/capacity information collection program 11410, a record is added to the configuration information table 115220.

The configuration information table 115220 includes host names 115221, volume numbers 115222, storage names 115223, data I/F numbers 115224, logical volume numbers 115225, virtualized pool numbers 115226 and physical disk numbers 115227.

The host name 115221 stores an identifier used for uniquely identifying a host 30000. The volume number 115222 stores an identifier used for uniquely identifying a volume in the host 30000 mounting a logical volume 22100 in the storage system 20000.

The storage name 115223 stores an identifier used for uniquely identifying a storage system 20000 providing the volume corresponding to the volume number 115222.

The data I/F number 115224 stores an identifier used for uniquely identifying a number of a data I/F 26000 used by the host 30000 for making access to the volume corresponding to the volume number 115222.

The logical volume number 115225 stores an identifier used for uniquely identifying a logical volume 22100 used by the volume corresponding to the volume number 115222.

The virtualized pool number 115226 stores an identifier used for uniquely identifying a virtualized pool 22400. The physical disk number 115227 stores an identifier for uniquely identifying a physical disk 22200 used by the volume corresponding to the volume number 115222.

It should be noted that a record which stores “-” in the host name 115221 and the volume number 115222 represents a state in which a storage is not allocated to a host 30000. Moreover, a record which stores “-” in the virtualized pool number 115226 represents that the volume provided to a host 30000 is a logical volume 22100.

FIG. 31 describes an example of the capacity information table 115320 stored in the system management repository 11500 according to the fourth embodiment of this invention.

The capacity information table 115320 stores capacity information of SAN components such as logical volumes 22100, physical disks 22200, virtual volumes 22300, and virtualized pools 22400 in the storage systems 20000, and capacity thresholds of the SAN components. As a result of execution of the configuration/capacity information collection program 11410, a record is added to the capacity information table 115320.

On this occasion, the capacity threshold represents a value set in advance to a resource to be managed in order to monitor a used quantity of a storage volume in the virtualized pool 22400, or the like. With this configuration, for example, the management server 10000 can take an action such as notification to a user when the value of the capacity information exceeds the capacity threshold during operation.

The capacity information table 115320 contains storage names 115321, resource numbers 115322, used capacities 115323, remaining resource capacities 115324, and remaining resource capacity thresholds 115325.

The storage name 115321 stores an identifier used for uniquely identifying a storage system 20000. The resource number 115322 stores a virtual volume number or a virtualized pool number used for uniquely identifying a virtual volume 22300 or a virtualized pool 22400 created on the storage system 20000 corresponding to the storage name 115321.

The used capacity 115323 stores a capacity of the total capacity or a capacity used as a virtual volume 22300 of a virtualized pool 22400 corresponding to the resource number 11532, or the capacity of a virtual volume 22300 corresponding to the resource number 11532.

The remaining resource capacity 115324 stores a remaining available capacity of the total capacity of the virtualized pool 22400. The remaining resource capacity threshold 115325 stores a threshold of the capacity set to the virtualized pool 22400.

When the resource number 115322 stores a virtual volume number representing a virtual volume 22300, “-” is stored in the remaining resource capacity 115324 and the remaining resource capacity threshold 115325.

According to the fourth embodiment of this invention, in order to refer to the capacity information as an index used for simulating influence of execution of a task, the management server 10000 includes the capacity information table 115320, but this invention is not limited to this configuration. For example, the management server 10000 may include a table containing an index monitored using thresholds in performance information or cost information.

The migration management table 11540 and the task classification table 11550 stored in the system management repository 11500 are respectively the same as those illustrated in FIGS. 8 and 9 of the first embodiment of this invention, but the migration management table 11540 is illustrated as an example according to the fourth embodiment of this invention.

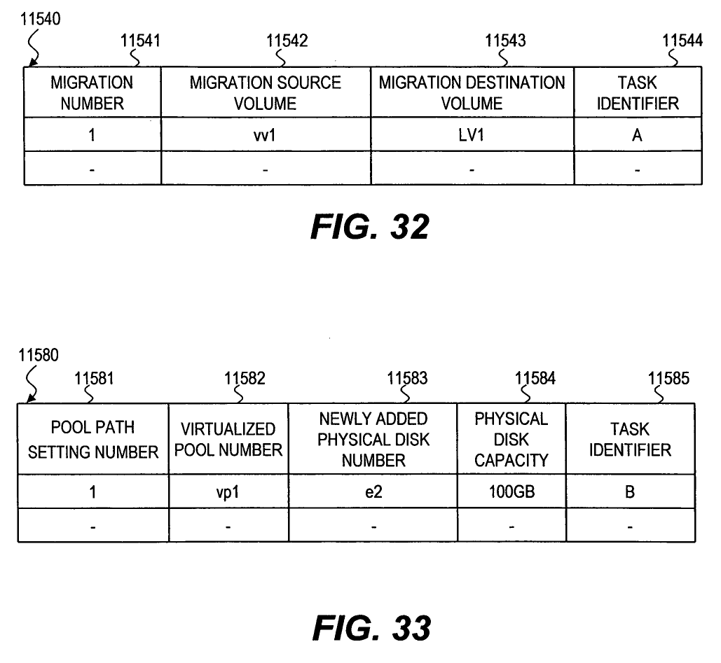

FIG. 32 describes an example of the migration management table 11540 stored in the system management repository 11500 according to the fourth embodiment of this invention. The configuration of the migration management table 11540 is the same as the configuration of the migration management table 11540 according to the first embodiment of this invention, and hence description thereof is omitted.

FIG. 33 describes an example of the virtualized pool management table 11580 stored in the system management repository 11500 according to the fourth embodiment of this invention.

The virtualized pool management table 11580 stores information necessary for the task execution program 21300 provided to a storage system 20000 to allocate a new storage volume to a virtualized pool 22400. As a result of the execution of the task management program 11140, a record is added to the virtualized pool management table 11580.

The virtualized pool management table 11580 contains pool path setting numbers 11581, virtualized pool numbers 11582, newly added physical disk numbers 11583, physical disk capacities 11584, and task identifiers 11585.

The pool path setting number 11581 stores an identifier for uniquely identifying an operation to allocate a storage volume to a virtualized pool 22400. The virtualized pool number 11582 stores a virtualized pool number used for uniquely identifying the virtualized pool 22400 which corresponds to the pool path setting number 11581, and is to be handled by the storage volume allocation.

The newly added physical disk number 11583 stores a physical disk number used for uniquely identifying a physical disk 22200 to be added to the virtualized pool 22400 corresponding to the virtualized pool number 11582.

The physical disk capacity 11584 stores the capacity of the physical disk 22200 corresponding to the newly added physical disk number 11583. The task identifier 11585 stores an identifier for uniquely identifying a task.

According to the fourth embodiment of this invention, as an example of the task, the operation for adding the physical disk 22200 to the virtualized pool 22400 and the migration are described, and the management server 10000 thus includes the virtualized pool management table 11580 and the migration management table 11540, but this invention is not limited to this configuration. For example, the management server 10000 may manage other functions such as copying as a task, and may include management tables corresponding to the respective functions.

A description is now given of task management processing carried out by respective programs on the management server 10000. Steps 1001 and 1003 are the same as those of the first embodiment of this invention, and hence description thereof is omitted. A description is now given of Steps 1002 and 1004 focusing on differences from the first embodiment of this invention.

FIG. 34 is a flowchart detailing processing (Step 1002) carried out to register the new task in the task management table 115120 by the task management program 11140 stored in the management server 10000 according to the fourth embodiment of this invention. It should be noted that, referring to this flowchart, a description is given of an example of a case in which an operation for newly adding a physical disk 22200 to a virtualized pool 22400 is planned.

The task management program 11140 receives task information by a user or an arbitrary program (Step 100221). The task information contains a virtualized pool number and a physical disk number.

The task management program 11140, based on the received task information, creates a new entry in the virtualized pool management table 11580, and sets the virtualized pool number 11582, the newly added physical disk number 11583, the physical disk capacity 11584, and the task identifier 11585 (Step 100222).

The task management program 11140, based on the received task information, creates a new entry in the task management table 115120, and sets the task type 115122 and the task identifier 115121 (Step 100223). It should be noted that, to the task identifier 115121, the same identifier as the task identifier 11585 in the virtualized pool management table 11580 is set.

Then, the task management program 11140 refers to the virtualized pool management table 11580, and acquires resources to be processed by the task (Step 100224).

The task management program 11140 acquires resources related, in terms of configuration or setting, to the acquired resources to be processed by the task from the configuration information table 115220, and sets the acquired resources respectively to the task-related resources 115124, 115125, and 115126 in the task management table 115120 (Step 100225).

The task management program 11140 determines whether the newly planned task is a task planned by a user or not (Step 100226).

When the task management program 11140 determines that the newly planned task is planned by a user, the task management program 11140 prompts the user to input an object of the task execution (Step 100227), sets a result of the user input to the task execution factor 115123 of the task management table 115120 (Step 100228), and proceeds to Step 100230.

In Step 100226, when the task management program 11140 determines that the newly planned task is not planned by a user, namely when the task is planned by an arbitrary program, the task management program 11140 acquires a reason of the planned task execution from the program which has transmitted the task information, sets the acquired reason of the planned task execution to the task execution factor 115123 of the task management table 115120 (Step 100229), and proceeds to Step 100230.

The task management program 11140 sets “Not Yet Executed” to the task execution status 115127 (Step 100230), and finishes the processing.

FIGS. 35A and 35B are flowcharts detailing processing (Step 1004) carried out to determine whether the new task is to be executed or not by the task execution determination program 11340 stored in the management server 10000 according to the fourth embodiment of this invention.

First, the task execution determination program 11340 acquires the planned tasks extracted by the execution of the inter-task relationship extraction program 11200 (Step 100421).

Then, the task execution determination program 11340 carries out the following processing for the respective planned tasks acquired in Step 100421 (Step 100422).

The task execution determination program 11340 refers to the task management table 115120, and determines whether the task execution status 115127 of the acquired planned task is “Execution Completed” (Step 100423).

When the task execution determination program 11340 determines that the task execution status 115127 of the acquired planned task is “Execution Completed”, the task execution determination program 11340 deletes this task from the task management table 115120 and the tasks acquired in Step 100421 (Step 100427), and proceeds to Step 100428.

When the task execution determination program 11340 determines that the task execution status 115127 of the acquired planned task is not “Execution Completed”, the task execution determination program 11340 acquires related resources of this planned task from the task management table 115120 (Step 100424).

Then, the task execution determination program 11340 acquires capacity information of the respective acquired related resources from the capacity information table 115320 (Step 100425).

The task execution determination program 11340 simulates capacity values of the respective related resources after the planned task is executed (Step 100426).

The task execution determination program 11340 determines whether all the acquired planned tasks have been processed (Step 100428).

When the task execution determination program 11340 determines that all the acquired planned tasks have not been processed, the task execution determination program 11340 returns to Step 100422, and carries out the processing from Step 100422 to Step 100428.

When the task execution determination program 11340 determines that all the acquired planned tasks have been processed, the task execution determination program 11340 acquires the related resources of the new task from the task management table 115120 (Step 100429).

Then, the task execution determination program 11340 acquires the remaining resource capacity thresholds 115325 of the respective related resources of the new task acquired from the capacity information table 115320 (Step 1004301).

The task execution determination program 11340 determines whether the simulated capacity values satisfy the remaining resource capacity thresholds 115325 of the related resources of the new task acquired in Step 1004301 (Step 1004302)

When the task execution determination program 11340 determines that the simulated capacity values satisfy the acquired remaining resource capacity thresholds 115325 of the related resources of the new task, the task execution determination program 11340 deletes the new task from the task management table 115120 and the virtualized pool management table 11580 (Step 1004303), and finishes the processing.

When the task execution determination program 11340 determines that the simulated capacity values do not satisfy the acquired remaining resource capacity thresholds 115325 of the related resources of the new task in Step 1004302, the task execution determination program 11340 acquires the task execution status 115127 of the new task from the task management table 115120 (Step 1004304).

The task execution determination program 11340 determines whether the acquired task execution status 115127 of the new task is “Not Yet Executed” or not (Step 1004305).

When the task execution determination program 11340 determines that the acquired task execution status 115127 of the new task is not “Not Yet Executed”, the task execution determination program 11340 finishes the processing.

When the task execution determination program 11340 determines that the acquired task execution status 115127 of the new task is “Not Yet Executed” in Step 1004305, the task execution determination program 11340 carries out the following processing for the respective planned tasks acquired in Step 100421 (Step 1004306). When there are tasks deleted in Step 100427, the following processing is not executed for those deleted tasks.

The task execution determination program 11340 acquires the task execution status 115127 of the planned task from the task management table 115120, and determines whether the acquired task execution status 115127 is “Execution Completed” (Step 1004307).

When the task execution determination program 11340 determines that the acquired task execution status 115127 is “Execution Completed”, the task execution determination program 11340 returns to Step 100422, and carries out the processing starting from Step 100422.

In Step 1004307, when the task execution determination program 11340 determines that the acquired task execution status 115127 is not “Execution Completed”, the task execution determination program 11340 determines whether all the planned tasks have been processed (Step 1004308).

When the task execution determination program 11340 determines that all the planned tasks have not been processed, the task execution determination program 11340 returns to Step 1004306, and carries out the processing starting from Step 1004306.

When the task execution determination program 11340 determines that all the planned tasks have been processed, the task execution determination program 11340 returns to Step 1004305, and carries out the processing starting from Step 1004305.

According to the fourth embodiment of this invention, “TASK B” is planned as the new task, and “TASK A” is extracted as the planned task related to the new task.

The task execution determination program 11340, for the virtual volume 22300 (vv1), the logical volume 22100 (LV1), the virtualized pool 22400 (vp1), and the physical disk 22200 (e1, e3), which are the related resources of “TASK A”, by simulating the capacity values resulting from the archive, can predict that the remaining resource capacity 115324 of the virtualized pool 22400 (vp1) becomes from 90 to 190, and the remaining resource capacity 115324 of the virtual volume 22300 (vv1) becomes from 100 to 0.

As a result, the task execution determination program 11340 recognizes that the remaining resource capacity 115324 of the virtualized pool 22400 (vp1), which is a task execution factor 115123 of “TASK B”, satisfies the remaining resource capacity threshold 115325, and can thus eliminate “TASK B” as an unnecessary task.

According to the fourth embodiment of this invention, by associating an execution factor of a task, and resources related to the task in terms of configuration or setting, as additional information, with the task, thereby managing the task associated with the additional information, it is possible to determine, by simulating a result including influence of tasks which are not considered in the task of interest, the necessity of the task execution.

As a result, when the task execution is not necessary, it is possible to eliminate the unnecessary task by canceling the execution of the task, for example.

Moreover, the fourth embodiment of this invention especially provides, by carrying out the simulation whenever necessary while employing values actually measured for tasks which have been executed, an effect of an increased precision for determining the necessity of the task execution.

The above-mentioned first to fourth embodiments of this invention may be combined in any manner. Moreover, the “tables” according to this invention such as the performance information table 11530 contained in the system management repository are not necessarily structured as tables, and may be configured in other data structure such as link lists. In order to clarify this point, the “table” may be considered as “information” which does not have a specific data structure.

While the present invention has been described in detail and pictorially in the accompanying drawings, the present invention is not limited to such detail but covers various obvious modifications and equivalent arrangements, which fall within the purview of the appended claims.

What is claimed is:

1. A management computer coupled to a host computer and a storage system including a plurality of storage devices, generating a logical volume from the plurality of storage devices, and allocating the generated logical volume as an allocated logical volume to the host computer, comprising:
a memory storing configuration information including information on a resource included in an I/O path from the host computer to the plurality of storage devices used to generate the allocated logical volume; and
a processor associating, in a case where first processing involving a change in a configuration of the host computer or the storage system is planned, the resource to be processed by the first processing and an execution purpose of the first processing, and managing the resource and the execution purpose,
wherein the processor extracts other processing which processes the resource to be processed by the first processing, and refers to the resource to be processed by the extracted other processing and an execution purpose of the other processing, to thereby determine whether the first processing needs to be executed or not.

2. The management computer according to claim 1, wherein:
the other processing includes second processing which is different from the first processing in at least one of content and an execution purpose of the other processing; and
the processor simulates a result to be obtained in a case where the second processing is executed, and determines whether the execution purpose of the first processing is attained or not based on the result of the simulation in a case where the processor determines whether the first processing needs to be executed or not.

3. The management computer according to claim 2, wherein, in a case where the processor determines whether the first processing needs to be executed or not, the processor determines whether the execution purpose of the first processing is attained or not after one piece of the other processing is executed, and in a case where the processor determines that the execution purpose of the first processing is not attained, the processor determines whether the execution purpose of the first processing is attained or not after another one piece of the other processing is further executed.

4. The management computer according to claim 1, wherein:
the other processing includes third processing executed after the first processing; and
in a case where the processor determines whether the first processing needs to be executed or not, the processor simulates a result to be obtained in a case where the third processing is executed, and determines whether the execution purpose of the first processing is attained or not based on the result of the simulation.

5. The management computer according to claim 1, wherein:
the other processing includes fourth processing which has the same execution purpose as the first processing, and cannot be simultaneously executed; and
in a case where the processor determines whether the first processing needs to be executed or not, the processor simulates a result to be obtained in a case where the fourth processing is executed, and determines whether the execution purpose of the first processing is attained or not based on the result of the simulation.

6. The management computer according to claim 1, wherein the first processing and the other processing are migration processing.

7. The management computer according to claim 1, further comprising an output device, wherein, in a case where it is determined that the first processing needs not to be executed, the processor is configured to at least one of:
(1) delete the first processing;
(2) request the output device to output a notification asking whether a presence of processing without necessity of execution causes a problem or not;
(3) determine whether asking a user if the execution purpose of the first processing is one of satisfied by the other processing later executed and satisfied immediately; and
(4) request the output device to output a notification asking whether, although the execution purpose of the first processing is satisfied by the execution of the first processing, the other processing executed later dissatisfies the execution purpose causes a problem or not.

8. A processing management method in a computer system comprising a storage system, a host computer making access to the storage system, and a management computer for managing the storage system and the host computer, the processing management method including the steps of:
generating, by the storage system, a logical volume from at least one storage device, and allocating the generated logical volume to software running on the host computer;
managing, by the management computer, configuration information including information on a resource included in an I/O path from the host computer to the at least one storage device used to generate the logical volume allocated to the software running on the host computer;
associating, by the management computer, in a case where first processing involving a change in a configuration of a computer system is planned, the resource to be processed by the first processing and an execution purpose of the first processing with the first processing, and managing the first processing associated with the resource to be processed and the execution purpose;
extracting, by the management computer, other processing which processes the resource to be processed by the first processing; and
referring to, by the management computer, the resource to be processed by the extracted other processing and an execution purpose of the other processing, and determining whether the first processing needs to be executed or not.

9. The processing management method according to claim 8, wherein:
the other processing includes second processing which is different from the first processing in at least one of content and an execution purpose of the other processing; and
the determining whether the first processing needs to be executed or not includes:
simulating a result to be obtained in a case where the second processing is executed; and
determining whether the execution purpose of the first processing is attained or not based on the result of the simulation.

10. The processing management method according to claim 8, wherein the step of determining whether the first processing needs to be executed or not includes the step of:
determining whether the execution purpose of the first processing is attained or not after one piece of the other processing is executed; and
determining, in a case where it is determined that the execution purpose of the first processing is not attained, whether the execution purpose of the first processing is attained or not after another one piece of the other processing is further executed.

11. The processing management method according to claim 8, wherein:
the other processing includes third processing executed after the first processing; and
the step of determining whether the first processing needs to be executed or not includes the steps of:
simulating a result to be obtained in a case where the third processing is executed; and
determining whether the execution purpose of the first processing is attained or not based on the result of the simulation.

12. The processing management method according to claim 8, wherein:
the other processing includes fourth processing which has the same execution purpose as the first processing, and cannot be simultaneously executed; and
the step of determining whether the first processing needs to be executed or not includes the steps of:
simulating a result to be obtained in a case where the fourth processing is executed; and
determining whether the execution purpose of the first processing is attained or not based on the result of the simulation.

13. The processing management method according to claim 8, wherein the first processing and the other processing are migration processing.

14. The processing management method according to claim 8, further including at least one of the steps of, in a case where it is determined that the first processing needs not to be executed:
(1) deleting the first processing;
(2) transmitting a notification asking whether a presence of processing without necessity of execution causes a problem or not;
(3) asking a user whether the execution purpose of the first processing is one of satisfied by the other processing later executed and satisfied immediately; and
(4) transmitting a notification asking whether, although the execution purpose of the first processing is satisfied by the execution of the first processing, the other processing executed later dissatisfies the execution purpose causes a problem or not.

15. The management computer according to claim 1, wherein:
the memory stores:
a configuration-performance-information collection program for obtaining the configuration information;
a task management program for generating a task management table for associating newly planned processing, an execution purpose of the newly planned processing, and a resource to be processed by the newly planned processing with each other, and for managing the newly planned processing associated with the resource to be processed and the execution purpose;
an inter-task-relationship extraction program for extracting relationship information between the newly planned processing and already planned processing; and
a task classification table for storing the task management table and priority indicating whether processing is to be executed unconditionally or not; and
the processor:
in a case where new processing is planned, obtains information on the newly planned processing, and generates an entry related to the newly planned processing in the task management table based on the obtained information;
associates an execution purpose of the newly planned processing and a resource to be processed by the newly planned processing with the newly planned processing, and manages the newly planned processing associated with the resource and the execution purpose;
obtains the execution purpose of the newly planned processing from the task management table;
refers to the task classification table based on the obtained execution purpose and determines whether the newly planned processing is to be executed unconditionally or not;
refers to the task management table and extracts already planned processing for processing the resource to be processed by the newly planned processing in a case where the newly planned processing is not to be executed unconditionally;
simulates a performance value of the resource to be processed by the newly planned processing in a case the extracted already planned processing is executed;
determines whether the execution purpose of the newly planned processing is attained or not based on a result of the simulation; and
deletes the entry of the newly planned processing from the task management table in a case where the execution purpose of the newly planned processing is determined to be attained based on the result of the simulation.
